(19) United States
(12) Patent Application Publication
(10) Pub. No.: US 2009/0127328 A1
(43) Pub. Date: May 21, 2009

(54) BIOMETRIC MULTI-PURPOSE BIOMETRIC TERMINAL, PAYROLL AND WORK MANAGEMENT SYSTEM AND RELATED METHODS

(76) Inventor: Nebil Ben Aissa, Chicago, IL (US)

Correspondence Address: COOK ALEX LTD, SUITE 2850, 200 WEST ADAMS STREET, CHICAGO, IL, 60606, US

(21) Appl. No.: 12/275,120

(22) Filed: Nov. 20, 2008

Related U.S. Application Data
(63) Continuation-in-part of application No. 11/761,938, filed on Jun. 12, 2007.
Application No. 11/761,938 is a continuation-in-part of application No. 10/894,498, filed on Jul. 20, 2004, now Pat. No. 7,229,013.
Application No. 10/894,498 is a continuation-in-part of application No. 10/183,767, filed on Jun. 27, 2002, now Pat. No. 6,764,013.
(60) Provisional application No. 60/372,983, filed on Apr. 17, 2002.

(51) Int. Cl. G06K 7/01

(52) U.S. Cl. 235/377

(57) ABSTRACT

A time and attendance biometric terminal communicates with a payroll system via general packet radio service (GPRS) protocol. The biometric terminal may be remotely activated and set up by entry of its serial number and an internal activation token, which are both supplied after payment information is first entered and verified. Payroll stubs may be printed at a facsimile machine or at a remote printer by the steps of identifying a person, communicating with a payroll database to obtain payroll information for the identified person, communicating the payroll information for the identified person to the remote printer, and printing the obtained payroll information at the facsimile machine or at the remote printer as a payroll stub.

### CROSS-REFERENCE TO RELATED APPLICATIONS

This patent application is a continuation-in-part patent application of U.S. non-provisional patent application Ser. No. 11/761,938, filed on Jun. 12, 2007, which is a continuation-in-part patent application of U.S. non-provisional patent application Ser. No. 10/894,498, filed on Jul. 20, 2004, now U.S. Pat. No. 7,229,013, which is a continuation-in-part patent application of U.S. non-provisional patent application Ser. No. 10/183,767, filed on Jun. 27, 2002, now U.S. Pat. No. 6,764,013, which in turn is a non-provisional patent application of provisional patent application Ser. No. 60/372,983, filed on Apr. 17, 2002, the rights of priority of which are hereby claimed for this patent application.

### FIELD OF THE INVENTION

The present invention relates in general to a biometric multi-purpose terminal, payroll and work management system and related methods, and more particularly, to a multi-purpose terminal that employees may use after authentication with a biometric device, such as a finger print detector to check-in and check-out of work, to receive new work instructions or assignments, to review payroll details, to print a payroll stub, to execute financial transactions, to print a receipt of a financial transaction or to request a payroll advance based upon work hours accrued, and to perform other financial transactions. The invention also relates to systems and methods which utilize such multi-purpose APW biometric terminals, including deposit of net pay in a bank account associated with each employee's bankcard so that the pay is immediately accessible by each employee.

### BACKGROUND OF THE INVENTION

Most commercial biometric clocks give only text feedback when an employee punches in or punches out. Thus, if a user's fingerprint is not matched, the system displays a text message telling the user that access was denied, or emits an audible tone, such as a high pitch or buzzing sound, that can be annoying.

When using biometric fingerprint matching devices for purposes of access control to a secured building or for purposes of employee time and attendance tracking, most systems compare the person's captured and processed fingerprint (usually called “minutiae”) with a previously stored fingerprint impression, such as a finger print impression which was captured during registration of the employee on the system. Then, based upon the matching threshold, the system makes one of the following two decisions: (1) person is authenticated or (2) person is NOT authenticated.

Biometric time clock devices are used in the marketplace to electronically track employees, especially the clock-in and clock-out times of the employee. However, such devices are often expensive to install and operate, and most such devices require an upfront investment in hardware, software and installation services.

Unfortunately, in remote locations which may only require one or two employees, installing such a prior art biometric time clock may not be economically justifiable. This is primarily because the cost of installing and operating a remote biometric time clock may actually exceed the profits generated from a remote location with only one or two employees. As a result, many employers, in order to electronically track employees in remote locations, ask their employees to use a telephone timekeeping system to clock-in and clock-out. Such telephone systems may be easy to use and the applicable telephone number can be called from any remote work location. One example of such a telephone timekeeping system is disclosed in U.S. Pat. Nos. 5,646,839 and 5,963,912, both to Katz.

One of the main problems of using a telephone timekeeping systems to track remote employees at remote locations, is that employers do not have the ability to truly confirm the real identity of the remote employee, especially in a low cost way. Such telephone timekeeping solutions primarily consist of an employee dialing into an automated Interactive Voice Response (IVR) system, which interacts with the employee and asks him/her to key in his/her employee number and other work related information by pressing entries into the keypad of the telephone. Some solutions also require tracking of the caller identification number (caller-ID) by looking-up the telephone number which the employee uses to engage the IVR system, and matching it with a pre-registered number in a database. Using caller-ID lookup matching, enables the employer to confirm that the employee is calling from the work location (via caller-ID lookup) instead of calling from home or a non-business location and/or billing for non-worked hours. Although such methods establish that “an” employee called from the work location, such methods still fail to guarantee the identity of the employee.

Thus, although IVR-based telephone timekeeping systems are accurate in identifying the location of the call, such systems still can not eliminate “buddy punching”. Buddy punching is when a buddy who is on time at the work site clocks-in or clocks-out for a late or absent employee, usually a friend or buddy. This allows the absent employee to fraudulently collect full pay for non-worked hours.

The installation process for a time and attendance or an all purpose APW biometric terminal may be the most costly component of the system. That is, in some instances, the cost of installation may actually exceed the price of the APW biometric terminal, especially if travel by qualified personnel to a remote location is required. Moreover, configuration of the APW biometric terminal after installation is not infrequently beyond the capabilities of the customer and requires technical support.

For example, a typical installation procedure may involve sending a trained technician to the site. The technician configures the APW biometric terminal either via a Local Area Network (LAN) connection or via a phone line connection. The client pays for the technician's time, travel and lodging expenses. The technician sets up the APW biometric terminal's internet protocol (IP) address, gateway and domain name server (DNS) settings. The technician then connects the time clock to a local area network (LAN) connection which consists of plugging the system's RJ45 cable to the APW biometric terminals jack plug, or connecting it to a phone line by plugging an RJ11 jack plug to the system. The technician then configures the time clock for connection to a server. The technician leaves and another technical person may arrive to install polling software which communicates to the time clock and polls its data. Thereafter, it is the customer's responsibility to make sure that all connections are maintained on a daily basis and that the clock is connected on a daily basis.

One of the problems encountered when servicing low wage, non-English speaking employees is their lack of technology sophistication in using a time and attendance system. Furthermore, due to the distributed nature of the labor environment, other significant issues are encountered, such as that employees move from one remote location to another without much advance notice. In many cases employees quit or give managers little notice that they will be late. As a result, managers have to move their distributed labor around continuously. Thus, the registration of new employees becomes difficult since the location or site where they were originally registered is not necessarily where they will end up working. Furthermore, in the case of low wage employee, employee registration and paper-work is usually done at a “hiring office”. Once the employee is hired, has signed his/her employment related paperwork, he/she may be sent to work at the remote location.

The main objective of companies that pay employees electronically is to avoid costs associated with mailing and over-nighting paper paychecks and paper payroll stubs. The employer deposits the funds into the employee's bank account, or payroll card, then follows up with an email to the employee containing detail of his or her payroll stub information. However, if the employer has low wage employees that do not have access to the internet or to a computer, such employee is suddenly faced with an option to receive electronic payment without knowing his or her payroll stub receipt details. The employee, without access to a computer or the internet, is now forced to take on this solution without ever finding how much was his payroll check gross, net, deductions, FICA or any other deductions and bonuses. There is therefore a need to send an electronic payroll stub to an employee that has no access to a computer or the internet.

In a distributed remote location labor environment, employees are usually unsupervised. As a result, sometimes it takes a few weeks to truly discover what certain remote employees do in such remote locations. However, what if the employee in the remote location decided to remove the all purpose APW biometric terminal, place it at home, connect it to the internet, clock-in and clock-out of it on a daily basis; and receive pay for hours non-worked at the client site? How would someone find out without having to send a manager to the remote location on a daily basis to police the APW biometric terminal location and inventory? The present invention addresses these issues.

Some of the major problems when assigning work orders to remote employees are that (1) it is hard to track down employees that are running all over a large building location, (2) a manager needs to be dispatched to the work location in order to communicate the work to the specific employee, and (3) once the work is done, in most cases, there is no feedback mechanism to tie back to the customer and have him/her confirm that the work was actually done to the customer's satisfaction. How would you assign, track and get feedback from a low wage employee that has no mobile phone and might not speak English, and be able to tie his assigned work with customer satisfaction? What if the employee were foreign, how would you communicate the work to them, if the work was requested in English? How could you do it remotely without seeing him/her? The present invention addresses these issues.

Accordingly, there has been a long felt need for ways of providing for fast and economical installation of a APW biometric terminal.

An object of the present invention is to provide a wireless APW biometric terminal which will self-install and self-configure itself, thereby avoiding costly installation procedures.

Another object of the present invention is to provide a time and attendance APW biometric terminal which communicates with a payroll system via general packet radio service (GPRS) protocol.

Yet another object of the present invention is to provide a payroll stub at a facsimile machine.

A further object of the present invention is to provide a payroll stub at a remote printer.

### SUMMARY OF THE INVENTION

Another aspect of the present invention provides a low cost and simple way to confirm an employee's identity for time and attendance applications via the usage of an Interactive Voice Response (IVR) system and voice matching technology through real-time voice matching processing via a computer, or off-line with the help of a human operator. The person's voice and sound waves are captured, then computer-based voice-matching technology is applied in real-time, or the voice files are placed on a secure web site for a manager to review and confirm at a later time.

Typically, an employee goes to the remote work site, picks up a phone, dials an IVR system by calling a local or long distance number, and then follows the prompt given to him/her by the IVR system. For example, the IVR system may ask him/her to enter their employee number by using the telephone keypad. The IVR system then asks the employee to randomly speak a specific sentence. Such a sentence was spoken by the employee at the time of registration of the employee on the system. The system plays back a sentence which the employee spoke white being registered the first onto the system. The employee speaks the sentence. The system then tries to match the employee's current spoken sentence with the sentence which was previously stored on the system.

If the sentences match, the system accepts the clock-in or clock-out transaction and places it in the employee's timesheet. Thus, the employee will receive full pay for this transaction. If the sentences do not match, the system may ask the employee to try another attempt. This may involve speaking the same sentence again, or speaking an alternative sentence. The number attempts can be 2, 3 or more depending upon the setting selected by the employer.

If the employee does NOT speak or say anything, then the system recognizes that there are no words being spoken by the employee. Through a preset noise threshold, the telephone system asks the employee to speak something. If the employee refuses to speak, thus a true buddy punching situation where the buddy does not want to get caught, then the computer system will NOT accept the punch. If the employee speaks into the system, and the IVR computer cannot match the voice sentence sound file, then computer stores the files on the server and places them (securely) on the web for a manager to listen and authorize.

If there is no match again, then based on the number of attempts, the system captures the voice sentence from the last attempt, and instructs the employee to go ahead and start working. The system then highlights the clock-in or clock-out transaction as a “miss-matched” transaction, and notifies a human operator, such as the employee's manager. The manager, is then prompted to view a secure web report which displays all of the clock-in or clock-out transactions which require his/her attention. When the manager clicks on the actual link, and the voice files from the last attempt are presented to the manager for review. Based upon his/her familiarity with the employee's voice, the employee manager accepts or rejects the actual clock-in or clock-out.

In order to facilitate quick and economical installation, the all purpose APW biometric terminal preferably communicates in plurality of wireless modes. For example, the wireless communication protocols may include GPRS (General Packet Radio Service). GPRS wireless technology may be preferable in remote locations where a wired phone line is not available. WiFi (Wireless Fidelity) may be the best solution for a high speed wireless connection within a client's local office location. However, other communication protocols may be used including Wi-Max (Worldwide Interoperability for Microwave Access), SMS (Short Message Service), MMS (Multi-Media Messaging Service), or simply via cordless 56K wireless connection, where a local 900 MHz cordless modem is connected to a local fax line, and a transceiver on the all purpose APW biometric terminal connects to the cordless modem.

Thus, a time and attendance APW biometric terminal preferably communicates with a payroll system via general packet radio service (GPRS) protocol. The payroll system may also include a work management system. The time and attendance APW biometric terminal includes circuitry for encoding and decoding communications between the time and attendance APW biometric terminal and the payroll system in accordance with general packet radio service (GPRS) protocol.

Another aspect of the present invention is a method of providing for fast and economical installation of a APW biometric terminal including the steps of giving the APW biometric terminal a serial number and an internal activation token prior to sale, storing the serial number and an internal activation token in a secure database containing paired serial numbers and activation tokens, requesting whether the customer wants to operate the unit in a networked mode or in an off-line non-networked mode, downloading and uploading information directly from the APW biometric terminal's USB port if operating in the off-line mode, requesting the user to enter a code token in order to activate the APW biometric terminal if in the networked mode, requesting the customer to enter an activation key, logging onto a secure web site and entering the APW biometric terminal's serial number, and entering the customer's billing and payment information. When the entered information is verified and authenticated, payment is drawn, and the user is presented with the right activation token paired with the APW biometric terminal's serial number. When the customer enters the activation token on the APW biometric terminal, it becomes operational.

The APW biometric terminal knows automatically where to communicate, the usage of wireless communication enables it to dial home and send/receive transactions and setup information. Once the device is activated, the customer is being billed for the length of the APW biometric terminal's ongoing communication service. If the customer fails to pay his or her bills, then device is automatically deactivated, and the customer has to go back to the activation step again.

The problem displays itself when one tries to sell a wireless SPRS APW biometric device at a retail store. Since GPRS communication requires a Subscriber Identification Module (SIM) card, in order to communicate on a GPRS network such as AT&T, T-Mobile or Sprint service; it becomes almost impossible for a consumer to buy a non-communicating wireless APW biometric device at a retail store, walk to the local wireless service provider store, buy a SIM card (Subscriber Identification Module card), sign a contract with the wireless service provider (AT&T, T-Mobile or Sprint service), commit to a specific level of wireless data and voice communication plan, take the SIM card and stick it into the wireless APW device, unlock and configure the device to connect to the service provider, then start the device and point its wireless modem to communicate to a wireless gateway, then configure the wireless gateway to communicate the device's data to a remote and dedicated server onto which the client can view employee attendance, payroll, timesheet, messaging and payroll stub information. All such steps are very difficult for a typical consumer to do in a coordinated and error free way.

Furthermore, currently when a client purchases a biometric device, the manufacturer (or selling organization) either sends a trained technician to help install and setup the device for the client, or expecs the client to train themselves and install and setup the device on their own. Such activation and implementation logic works fine when the client is known after the sale. However, when the client is unknown, and he or she buys an off the shelf unit, there is no way for them to self-activate the device without the intervention and presence (local or via a remote conversation) of trained support person. Furthermore, if the client were to rent the device, and if the client is current on his or her wireless communication fees, but non-current on his or her monthly hardware rental fees, then because the wireless service is offered via a different provider than the hardware owner, it becomes difficult to stop the device from communicating on the wireless network, primarily because the wireless service company has no intention to stop the user from using its network. An idea comes to mind, which to bundle the wireless service with the rental of the device, however, such action means that the SIM card installed into the device (to enable GPRS wireless service) has to be activated at manufacturing, this way, the buyer of the device does not have to go through the hassle of pulling the SIM card, walking to the wireless service store, signing a wireless contract and activating it after the sale of the unit. Activating the SIM card at manufacturer results in the wireless service provider invoicing the APW manufacturer for wireless services from the first day of inception of the APW biometric device. This is a very unattractive business model for the APW manufacturer because the device could be sitting for a year or two in the retail store before sale. Thus, providing an intelligent remote activation and communication method saves the manufacturer and the user a lot of time and money and simplifies the process of selling a wireless APW biometric device.

The present invention therefore includes methods of automating the remote sale, activating and implementing a wireless, LAN or dialup APW biometric device operation when sold at a retail location, even though the client is unknown. This method manifests itself greatly when selling a wireless GPRS device with a pre-installed SIM card.

These intelligent remote activation and communication methods are made effective by enabling the device to always communicate to a home server (in LAN, dialup, or wireless connectivity mode) independently of system knowledge of the customer and his or her payment status. To solve the problem, the APW biometric device is pre-manufactured to support multiple communication capabilities: LAN, dialup, and wireless simultaneously. The device is pre-installed with a dormant inactive SIM card which can only be activated electronically. The pre-installed dormant inactive SIM card increases the cost of the device. However, it simplifies its activation and communication once sold to a consumer.

Our approach includes building a live 24×7×365 activation server via secure web technology, which is always on and which is accessible to users who purchase a new APW biometric device off-the-shelf from a retail store, via a distributor, or via the web. The APW biometric device is pre-manufactured with a SIM card (in the case of a GPRS device) or present internal password in the case of a LAN or dialup device. Every time the APW biometric device communicates, it has to get a token from the activation server. If the device does not have an activation server, it is allowed to only talk to the home server, while a message is displayed to the user asking them to enter an activation token, and by giving them the option to go to a secure website and attain an activation token.

The user logs onto the activation server system, answers a few questions, enters his or her payment methodology, and then submits his information for processing. The activation server processes the information, receives approved payment, and then presents the user with an activation token.

The user enters the activation token onto the device, the device runs an internal off-line hashing methodology which deciphers the activation token and validates it. If the code is authentic and if it is valid, the device stores the activation token in memory and proceeds forward to the next step. Otherwise, it reverts back to asking the user to enter a valid activation token.

To activate the unit, the user is now asked to place the device on a dialup phone line or high speed LAN line such as DSL or other Cat-5 high speed network connections (at home or at the office). The device diagnoses the connectivity mode (either dialup dial-tone or high speed LAN), connects to a pre-defined remote server and communicates its activation token and SIM card number. The remote server then connects to the wireless service company (AT&T, T-Mobile, Sprint, or the like) secure servers and registers the SIM card number. This automatically activates SIM card communication service billing to the company and notifies the wireless service to allow communication from the SIM card number on the APW biometric device. The system then alerts the device to reboot itself, activates the dormant SIM card and start communicating via the wireless GPRS methodology using the newly registered and activated SIM card. This approach is the easiest and simplest for the user in order to automatically activate and start using his or her off-the-shelf purchased APW biometric device with multiple communication capabilities: wireless GPRS, dialup or LAN connectivity.

Another method, in case the user does not have access to a dialup connection or LAN, which is slightly more complicated for a user, is to ask the user to log into a secure web site where he or she is asked to enter the serial number of the device (serial number is always on the back of device). Upon entering the serial number, the system looks up such serial number and matches it with the corresponding SIM card number. The server then connects to the wireless service company (AT&T, T-Mobile, Sprint, or the like) secure servers and registers the SIM card number. This automatically activates SIM card communication service billing to the company and notifies the wireless service to allow communication from the SIM card number on the APW biometric device. The system then displays an activation code to the user, and asks the user to enter it on the device, which validates it and, if successful moves to the next step. If the code is not valid, then the user is prompted to enter a valid activation token. Once the user enters a valid activation token, the device automatically saves it in non-erasable memory, activates the dormant SIM, and then reboots itself. After the reboot sequence, the device starts communicating via the wireless GPRS methodology using the newly registered and activated SIM card. This approach is slightly more complicated for an unsophisticated user. However, it is an efficient approach to automatically activate and start using an off-the-shelf purchased APW biometric device via multiple communication capabilities: wireless GPRS, dialup or LAN connectivity.

The second major component of the intelligent remote activation and communication method is to build an authentication “Gateway” to police all communication from all remotely installed and activated devices. Once the device is activated, the device will always communicate to its home server (provided by the device's manufacturer) and to the client's dedicated information server. When communicating to the home server, the device communicates its activation token, then checks through the gateway if the client is in good standing in order to communicate to the client's dedicated server and pass information about client's employee attendance, timesheets, messages, payroll stubs, and the like. Using this process, If the user is current on his or her payment, then the communication Gateway server will route the information collected from the remote device to the user's dedicated server, which can be accessed by the user via a secure web login and password. If the user is not current on his or her payments, then the communication Gateway redirects communication traffic and blocks the information from being transferred onto the user's dedicated servers until payment is received. Another aspect of the present invention is to use the APW Biometric device color screen interface to enable the employee to correct and close his or her punches right off of the APW biometric device, instead of having the employee ask for manager permission to close his or her punch.

In the case an employee forgets to punch-out the day prior, the next day when they return to punch-in again, the system will tell the employee that he or she has an open punch-out from yesterday's shift which needs to be corrected. In order to save the manager time, especially in larger employee sites where 100 or more employees are working at the site, the system asks the employee to close and correct his or her own punch-out before he or she can punch-in again. The employee enters his or her estimated punch-out time at the end of the shift yesterday, upon completing such task, the device will now allow the employee to punch-in normally. Upon the manager accessing the APW biometric device or the labor management web site connected to the APW biometric device, the manager receives an immediate notification of the employee which manually corrected the punch-out. At that point, the manager is prompted to use his or her personal diligence to either accept the corrected punch as is, or override it with a different time and date set of values.

In the case an employee forgets to punch-in earlier in the shift, next time, when the user returns to punch-out, the system will tell the employee that he or she has an open punch-in from earlier in the shift which needs to be corrected. In order to save the manager time, especially in larger employee sites where 100 or more employees are working at the site, the system asks the employee to close and correct his or her own punch-in before he or she could punch-out again. The employee enters his or her estimated punch-in time earlier in the shift, upon completing such task, the device will now allow the employee to punch-out normally. Upon the manager accessing the APW biometric device or the labor management web site connected to the APW biometric device, the manager receives an immediate notification of the employee which manually corrected the punch-in. At that point, the manager is prompted to use his or her personal diligence to either accept the corrected punch as is, or override it with a different time and date set of values.

Another aspect of the present invention is the use of the APW biometric device to print hours worked, schedule, assignments and timesheet receipts.

Still another aspect of the present invention is the installation of a camera and the use of video or still picture to capture the image of the user at the moment his or her fingerprint image is captured. Taking a picture or video via a camera then storing it on the device, then sending it to a remote secure web server for further review either in real time via a web site, can greatly help both security personnel and employers have better audit tracking of people who used the APW biometric device to access a secure facility or work at the site.

APW biometric device may also be used to secure a door, thus only users with registered fingerprints are allowed through the door. A user places his or her fingerprint on the device, which reads their fingerprint, generates a minutia and compares it to the set of minutiae stored on the device. In case of a match or no match, the device captures a quick video, or a still picture of the user which attempted to enter the facility using his or her fingerprint. Then the device immediately sends the transaction and the video or image to a remote secure database. A secure web server then picks up the transactions and the corresponding video and still pictures and presents them in a web based report; so that security service personnel can review either at a later date or in real time; thus have an eye on intruders who have failed the fingerprint test, or help identify a familiar face who may need training in the use of the system.

In the case of using the APW biometric device to track employee attendance, thus only employees with registered fingerprints are allowed to punch-in and punch-out. A user places his or her fingerprint on the device, which reads their fingerprint, generates a minutia and compares it to the set of minutiae stored on the device. In case of a match or no match, the device captures a quick video, or a still picture of the user which attempted to punch-in or punch-out using his or her fingerprint. Then immediately sends the transaction and the video or image to a remote secure database. A secure web server then picks up the transactions and the corresponding video and still pictures and presents them in a web based report; so that a manager can review either at a later date or in real time: thus have an eye on employees that are using the system or help train users that are having trouble with the system or stop certain individuals from trying to buddy punch for each other.

Another aspect of the present invention is that, unlike other biometric time clocks that need a polling server to call them and download information from them, the APW biometric device dials out to a predefined phone number. This approach lowers the cost of communication for the installation. In the case of other devices which need a polling server and a dedicated phone line, clients pay a sizeable dedicated non-sharable phone line fee. However, by making the APW biometric device dial-out, the device can now split a phone line with a fax machine for example, or split a dialout office line and be able to communicate to a remote server without incurring any additional telecommunication fees.

Yet another aspect of the present invention is to position the fingerprint reader on the device's left hand side. Other biometric device manufacturers place the fingerprint reader on the right hand side of the device. We believe that only about 20 percent of the population is left-handed and, as such, use their left hands and fingers extensively. The remaining about 80 percent of the population keeps their left hands and left fingers relatively unused. By positioning the fingerprint reader on the left-hand side of the device, better quality, undamaged, un-scratched fingerprint impressions are obtained, thus increasing the likelihood of fingerprint matching success.

The payroll stub information is captured and stored on the server, then is placed in secure repository so it is easily sent to all the all purpose APW biometric terminals. The information is secured along employee information, fingerprint and profiles. The APW biometric terminals would also send employee hours worked, and would mark which hours have received payment from the employer and which did not. This gives us the ability to assess the amount of money to loan the employee, so we do not loan the employee money based on hours that were worked and paid. We will only pay the employee advances for hours that were worked but were unpaid by the employer.

The repository is then shared with financial institutions that want to be part of this network. Belonging to the repository of employee payroll stub and outstanding hours network enables them to lower the risk of their loans and increase the amount of volume, since in most economic situations, lowering prices results in increased business volume.

The employee then visits the subscribed financial service location, networked to the repository, and either finds a all purpose APW biometric terminal, paces his/her fingerprint and receives a lower risk, lower cost payday loan. Or, the local service counter operator, logs into the repository via a secure location and runs a credit history on the employee directly from the repository network. Once done, the employee leaves with the cash, and debt payments are automatically deducted from the employee's next payroll check.

This invention organizes and simplifies the delivery of an electronic stub to an employee that has no access to internet or computers. For example, a method of printing a payroll stub at a facsimile machine may include the steps of identifying a person, communicating with a payroll database to obtain payroll information for the identified person, providing a telephone number associated with the facsimile machine, communicating the payroll information for the identified person to the facsimile machine, and printing the obtained payroll information at the facsimile machine as a payroll stub. The identified person provides the telephone number associated with the facsimile machine. The person may be identified by at least one of the group consisting of a bankcard, a biometric reader, a voice segment, a video segment or caller ID. The person may also or alternatively be identified by an interactive voice response system.

The present invention also provides for printing a payroll stub at a facsimile machine. Typical steps include identifying a person, communicating with a payroll database to obtain payroll information for the identified person, communicating the payroll information for the identified person to the remote printer, and printing the obtained payroll information at the remote printer as a payroll stub. The person may be identified by at least one of the group consisting of a bankcard, a biometric reader, a voice segment, a video segment or caller ID. The person may also or alternatively be identified by an interactive voice response system.

### BRIEF DESCRIPTION OF THE DRAWINGS

The features of the present invention which are believed to be novel are set forth with particularity in the appended claims. The invention, together with the further objects and advantages thereof, may best be understood by reference to the following description taken in conjunction with the accompanying drawings, in the several figures in which like reference numerals identify like elements, and in which:

FIG. 1 is a front diagrammatic view of an electronic APW terminal, with a biometric device suited for reading biometric information from an employee, and that provides a plurality of functions in accordance with the present invention.

FIG. 2A is a diagrammatic view of the electronic APW terminal illustrated in FIG. 1 in combination with a bar code scanner to monitor an inventory of supplies at a job site.

FIG. 2B is a diagrammatic view of the electronic APW terminal illustrated in FIG. 1 in combination with a wireless bar code scanner to monitor or track equipment at a job site.

FIG. 3 is a block diagram of the internal structure and functionality of the electronic APW illustrated in FIGS. 1 and 2A-2B.

FIG. 4 is a simplified block diagram illustrating one embodiment of the present invention in which payroll funds are credited from an account in the employer's bank to the employee's bankcard account for access at an ATM or a point of sale terminal.

FIG. 5 is another simplified block diagram, similar to FIG. 4, illustrating another embodiment in which the employer's bank is also the card-issuing bank.

FIGS. 6A and 6B are a flowchart illustrating the steps employed by the electronic APW terminal and a computer to authenticate a bankcard number and PIN including the various options available after authentication, such as checking-in or checking-out of work on the electronic APW terminal illustrated in FIGS. 1-5.

FIG. 7 is block diagram illustrating the entire ATM, payroll and work management system in greater detail than FIGS. 4 and 5.

FIG. 8 is an exploded block diagram of the central processing server array shown in FIGS. 4, 5 and 7.

FIGS. 9A-9G illustrate typical screens that may be used on the display of the electronic APW terminal shown in FIG. 1 during authentication of an employee or supervisor before he/she can gain access to initiate additional functions or procedures.

FIGS. 10A-10C illustrate typical screens that may be used on the display of the electronic APW terminal during punching in at work.

FIGS. 11A-11B illustrate typical screens that may be used on the display of the electronic APW terminal during punching out at work.

FIGS. 12A-12F illustrate the typical screens used on the display of the electronic APW terminal of FIG. 1 to enable an employee to correct any missed punch-ins.

FIGS. 13A-13G illustrate the typical screens used on the display of the electronic APW terminal of FIG. 1 to enable an employee to correct any missed punch-outs.

FIGS. 14A-14B illustrate the typical screens used on the display of the electronic APW terminal of FIG. 1 to review and print any messages.

FIGS. 15A-15D illustrate typical screens that may be used on the display of the electronic APW terminal of FIG. 1 to review a payroll and to print a pay stub.

FIGS. 16A-16D illustrate typical screens that may be used on the display of the electronic APW terminal of FIG. 1 to review the balance remaining on the bankcard and to print the balance.

FIGS. 17A-17D illustrate the typical screens used on the display of the electronic APW terminal of FIG. 1 by an employee to obtain a payroll advance against currently accrued pay.

FIG. 18 is a flow chart of typical steps involved in interactive messaging, such as between a manager and an employee with the employee sending a reply to the manager from the electronic APW terminal.

FIG. 19 is a flow chart of typical alerts that the system of the present invention may generate upon monitoring the system or upon employee input into the system.

FIGS. 20A and 20B are a flow chart of typical steps involved in calculating and approving a payroll advance.

FIG. 21 is a flow chart that provides further detail on authentication with the fingerprint reader.

FIG. 22 is a flow chart providing details of printing a payroll stub from an electronic APW terminal.

FIG. 23 is a front diagrammatic view of the preferred embodiment of an electronic APW biometric terminal in accordance with the present invention, with a biometric device suited for reading biometric information from an employee and alternative means for providing a second opinion concerning the authentication of a person, and which provides a plurality of other functions in accordance with the present invention.

FIGS. 24A and 24B are flowcharts illustrating the steps employed by the electronic APW biometric terminal shown in FIG. 23 in providing a second opinion to authenticate an employee or to permit a person to have access to a secure building, respectively.

FIG. 25 is a flowchart illustrating in more detail typical steps which may be employed by the electronic APW biometric terminal shown in FIG. 23 in providing a second opinion to authenticate an employee or person.

FIGS. 26A and 26B are flowcharts illustrating typical steps which may be employed to remotely authenticate employees in an interactive voice response (IVR) system, with a second opinion provided by human intervention when the IVE system is unable to confirm a match.

FIGS. 27R and 27B are flowcharts illustrating typical steps which may be employed in quickly activating a APW biometric terminal upon installation of the APW biometric APW biometric terminal in its place of use.

FIGS. 28A and 28B are flowcharts illustrating typical steps which may be employed to provide a payroll stub at a facsimile machine or at a remote printer.

FIG. 29 is a flowchart illustrating the difficulties that a typical customer has with respect to purchasing a non-communicating wireless GPRS APW biometric terminal and configuring the terminal into a communicating mode.

FIG. 30 is a flowchart illustrating the difficulties that a typical customer has with respect to having third parties assist in installing an off-the-shelf GPRS APW biometric terminal.

FIG. 31 is a flowchart illustrating methods of enabling a customer to activate a GPRS APW biometric terminal.

FIG. 32 is a flowchart illustrating the activation details for a GPRS APW biometric terminal.

FIG. 33 is a flowchart illustrating a method for acquiring an activation token for a GPRS APW biometric terminal.

FIG. 34 is a flowchart illustrating how the GPRS APW biometric terminal and the system use the activation token.

FIG. 35 is a flowchart illustrating a method of remotely activating a GPRS APW biometric terminal by a typical customer.

FIG. 36 is a flowchart illustrating method of remotely activating a GPRS APW biometric terminal by a typical customer when an LAN and dialup services are not available.

FIG. 37 is a flowchart of an authentication gateway.

FIG. 38 is a flowchart illustrating a method for handling a missed punch-out by an employee.

FIG. 39 is a flowchart illustrating a method for handling a missed punch-in by an employee.

FIG. 40 is a flowchart illustrating the printing capabilities of a GPRS APW biometric terminal.

FIG. 41 is a flowchart illustrating methods of using a camera on a GPRS APW biometric terminal.

FIG. 42 is a flowchart illustrating methods of using a GPRS APW biometric terminal to control access to a secure door, to a secure building or the like.

FIG. 43 is a flowchart illustrating methods for controlling buddy punching at a GPRS APW biometric terminal.

FIG. 44 is a flowchart illustrating a method for dialing out on demand from a GPRS APW biometric terminal.

FIG. 45 is a flowchart 690 illustrating the left-hand position of the biometric reader.

### DETAILED DESCRIPTION OF THE INVENTION

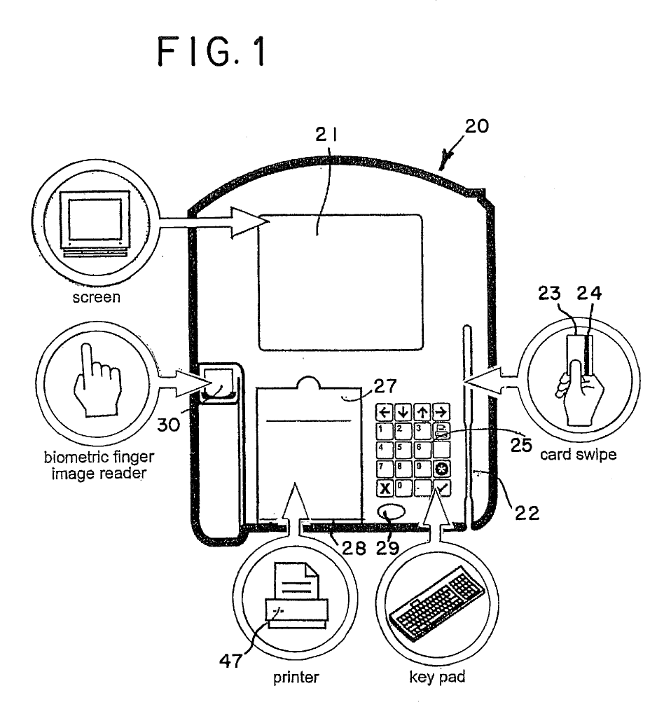

Referring to the Figures, and particularly to FIG. 1, an electronic APW terminal is generally designated 20. Electronic APW terminal 20 has ATM, payroll and work management (APW) capability, and may hereinafter also be referred to as an APW terminal 20. Disposed near an upper end of APW terminal 20 is a display screen 21 for displaying information, options, commands, work assignments, messages or the like. Display 21 may be of the liquid crystal display (LCD) type for displaying a plurality of different screens of information, as will be presented in greater detail below. The APW terminals may be located wherever employees usually check-in or check-out of work, such as at the employer's facilities, or at the customer's facilities in those instances where the employees work at the customer's facilities, such as for example, janitorial or cleaning staff.

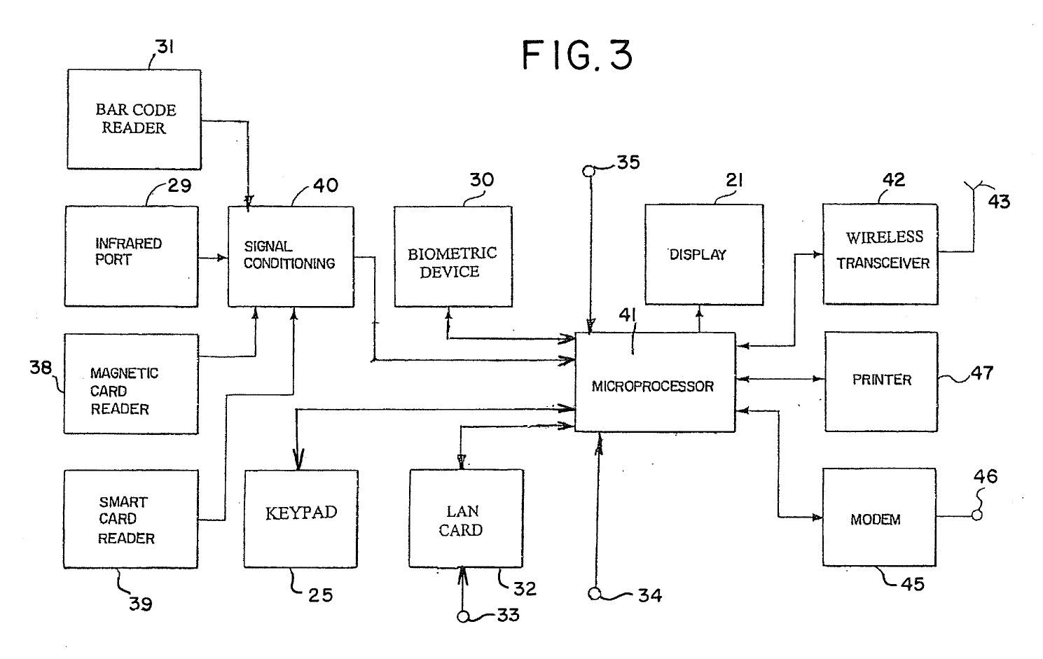

APW terminal 20 is equipped with a card reader 38 (FIG. 3) disposed alongside a slot 22 for reading a bankcard 23, a keyboard or keypad 25, a display 21, a printer port 28 and a biometric device 30. Card reader 38 reads the information contained on a magnetic stripe 24 of the bankcard 23, such as a bank account number. For example, card 23 may be a bankcard issued by a bank and the magnetic stripe may have a unique identifying number encoded therein which corresponds to one or more accounts at said bank. Of course, APW terminal 20 could alternatively be equipped to read information from smartcards. Since bankcard 23 is also used in the APW terminal as an ATM, payroll and work management (APW) card, card 23 may hereinafter also be referred to as an APW card.

Keypad 25 contains a plurality of keys for entering numeric information, for scrolling through the information displayed on display 26, for accessing a prior page or the next page, for entering selected information, and the like. For example, in addition to the ten numerals 0-9, keyboard 25 may have four keys; one each for scrolling up, down, right and left. In addition, keyboard 25 may have a key with a period for separating dollar and cent amounts, a key with circular indicia for starting desired functions such as reading a fingerprint on biometric device 30, a key with a printer symbol for printing the current screen appearing on display 21, a star button to continue a desired function, a key with a check mark for approving or responding to specific inquiries or options and a key with an “X” indicia for exiting the present function or for deleting information entered into APW terminal 20. Examples of the use of the various keys of keyboard 25 will be explained in greater detail below with respect to initiating and executing specific functions that are provided by APW terminal 20.

Printer port 28 has a printer 47 (FIG. 3) disposed behind an access door 27 and provision for containing a source of paper, such as a roll of paper, behind the access door. When the APW terminal 20 is instructed to print, the printed paper from a roll is dispensed through the printer port 28 such that the user may tear it off against the forward edge of the port. For example, an authenticated employee may obtain a print-out of a payroll stub relating to the most recent pay period including details about gross pay, deductions and net pay. Other types of printed information from APW terminal 20 may include current work assignments and/or locations, recent activity and balances in bank accounts related to the unique number of the bankcard, and the like. The results of work quality audits may also be made available for printing.

APW terminal 20 also preferably includes a biometric device 30, such as a fingerprint reader and comparator (hereinafter fingerprint reader). Due to the unique characteristics of human fingerprints, the fingerprint reader 30 may be used as the preferred form of employee identification, or to supplement the card reader 22 in its reading of the bankcard 23. For example, one of the frequently encountered problems of using the APW terminal 20 of FIGS. 1-5 is that the employee may forget or lose their bankcard and then be unable to check-in or checkout of work on the APW terminal 20 if only bankcard access to APW terminal 20 is permitted. However, with a biometric device 30 provided on APW biometric terminal 20, the employee will be able to check-in or checkout by applying their finger against the fingerprint reader even if their bankcard is not available at the time of check-in or checkout. This form of identification also provides excellent immunity to the buddy punching problem.

An infrared communications port 29 may be provided, as along the bottom edge of APW biometric terminal 20 in the embodiment shown in FIG. 1, to communicate with other devices that also utilize infrared communication means. For example, a supervisor of employees or a customer of employment services may enter information about new work assignments, or may provide information about previous work assignments that were not completed or that were unsatisfactorily completed. The supervisor or customer may also enter the new work assignments or the feedback on prior work assignments on a portable or laptop personal computer (PC) or a personal digital assistant (PDA) that is also equipped with an infrared communications port. Such information may then be received by the APW biometric terminal and communicated to a computer for processing, storage and/or later retrieval.

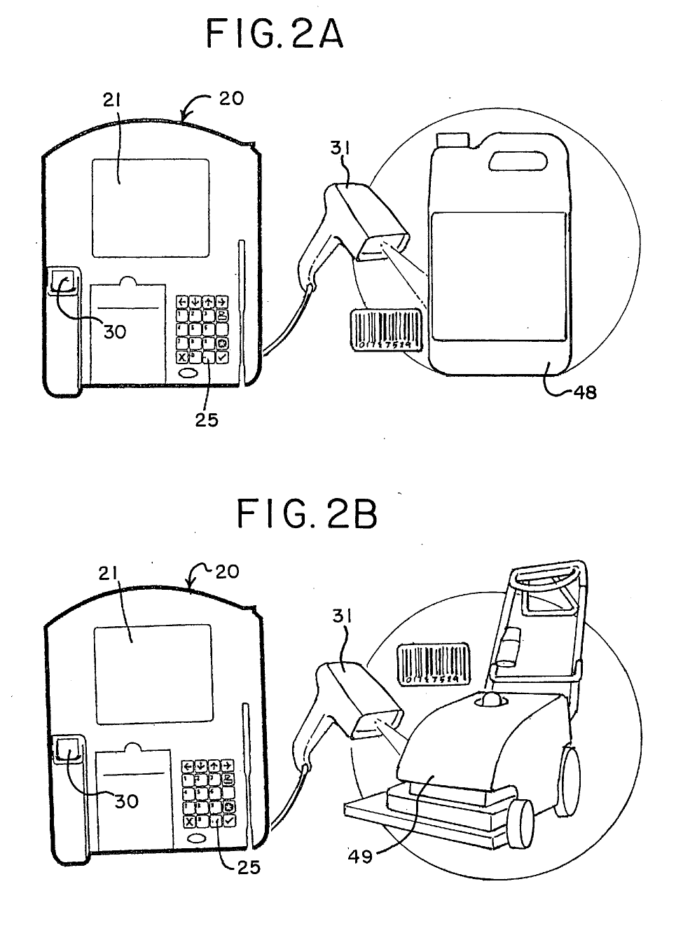

As shown in FIG. 2A, APW biometric terminal 20 may be equipped with a bar code reader 31, which may be used to read the bar codes on supplies, such as a container 48 of cleaning fluid or the like. Thus, the inventory of supplies may be tracked. Likewise, the bar code reader 31 may be used for convenient ordering or replenishing of supplies. In FIG. 2B, bar code reader 31 is of the wireless type and may be used for monitoring the usage of equipment, such as the floor cleaner 49, or for tracking such equipment.

The internal structure and functionality of APW biometric terminal 20 is illustrated in FIG. 3. As previously described, APW biometric terminal 20 has a magnetic card reader 38 disposed in the card slot 22 to read encoded information from the magnetic stripe 24 disposed on the bankcard 23. APW biometric terminal 20 may also be provided with a smartcard reader 39 to read information from a smartcard. As also previously described, APW biometric terminal 20 has an infrared port 29 to communicate with other devices having infrared ports, such as PCs and PDAs. Information signals from the magnetic card reader 38, the smartcard reader 39, bar code reader 31 and the infrared port 35 are preferably conditioned by signal conditioning circuitry 40 to provide input signals that are compatible with input terminals of a microprocessor 41. The biometric device 30 may interface directly with microprocessor 41. A LAN card 32 also interfaces with microprocessor 41 to provide further connectivity in the APW system 50 via and I/O port 33. Microprocessor 41 also receives inputs from the keypad 25. Microprocessor 41 may be any suitable microprocessor, microcontroller, data processor or the like.

Any of the information provided to APW biometric terminal 20 may be communicated to a computer or database, which may be remotely located. To this end, microprocessor 41 may supply input information to a radio frequency (RF) transceiver 42 for transmission via an antenna 43. The path of RF transmission may be by conventional antenna-to-antenna RF transmission, a microwave link, a satellite link, or the like. APW biometric terminal 20 also receives information from a remotely located computer or database via RF transmission in the reverse direction, such as from antenna 43 to RF transceiver 42 to microprocessor 41. Typically, microprocessor 41 will provide some of the received information for display on the display screen 21.

The microprocessor 41 in APW biometric terminal 20 preferably has sufficient dedicated memory, either internally or externally, to store the unique account numbers of the bankcards and the PINs of the employees that frequently use any particular APW biometric terminal 20. Authentication of those employees may then be done internally at APW biometric terminal 20 without having to communicate with a remote computer to access the appropriate account numbers and PINs. However, in such instances, APW biometric terminal 20 continues to communicate with a remote computer or database to provide the check-in and checkout times for processing of the payroll.

APW biometric terminal 20 may also communicate, separately or in tandem with the REF link, via a modem 45. Modem 45 has an output terminal or jack 46 to communicate bi-directionally with a remotely located computer or database either by means of the public switched telephone network (PSTN), by means of the internet, or the like.

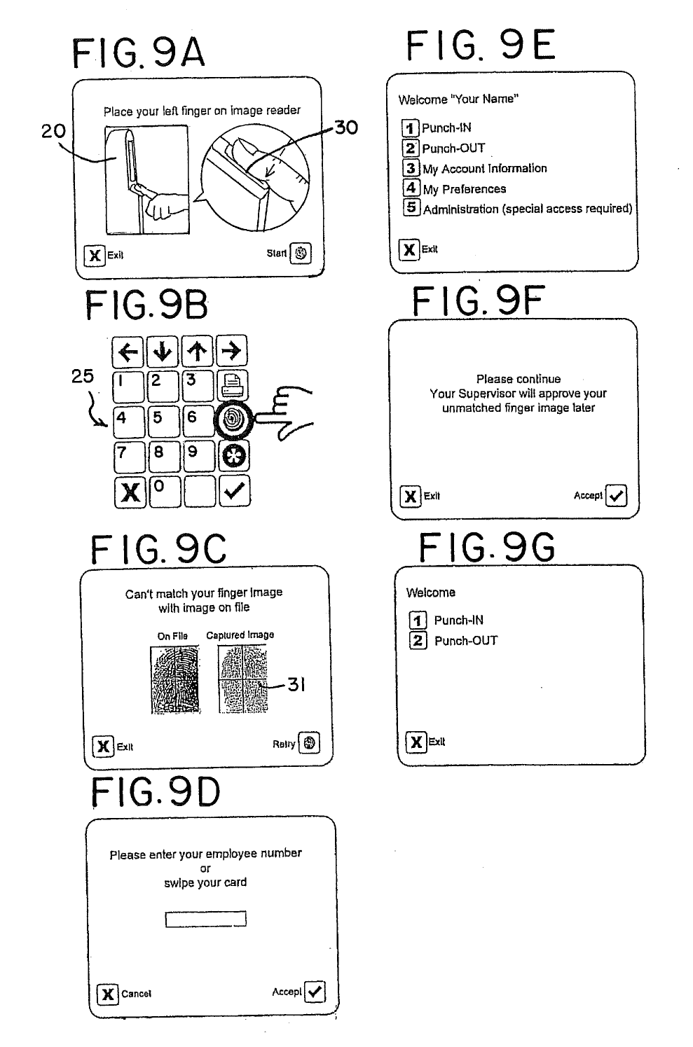

An internal printer 47 may be activated by the printer key on keypad 25 (FIG. 9B) to print information on display screen 21. The printed copy is provided through printer slot 28. Printer 47 may be of the thermal paper type or any other suitable type.

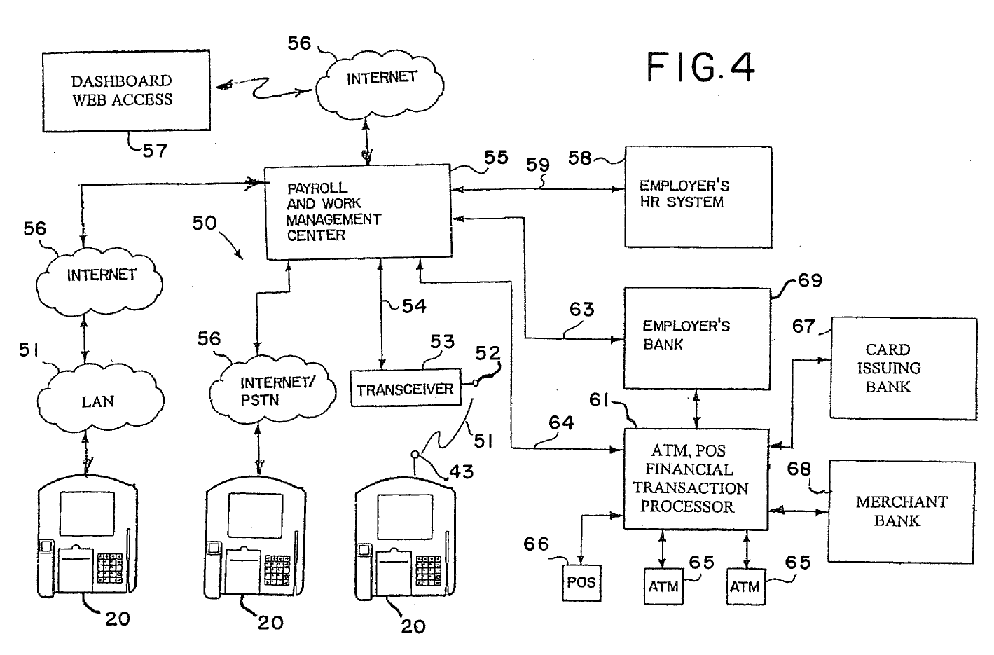

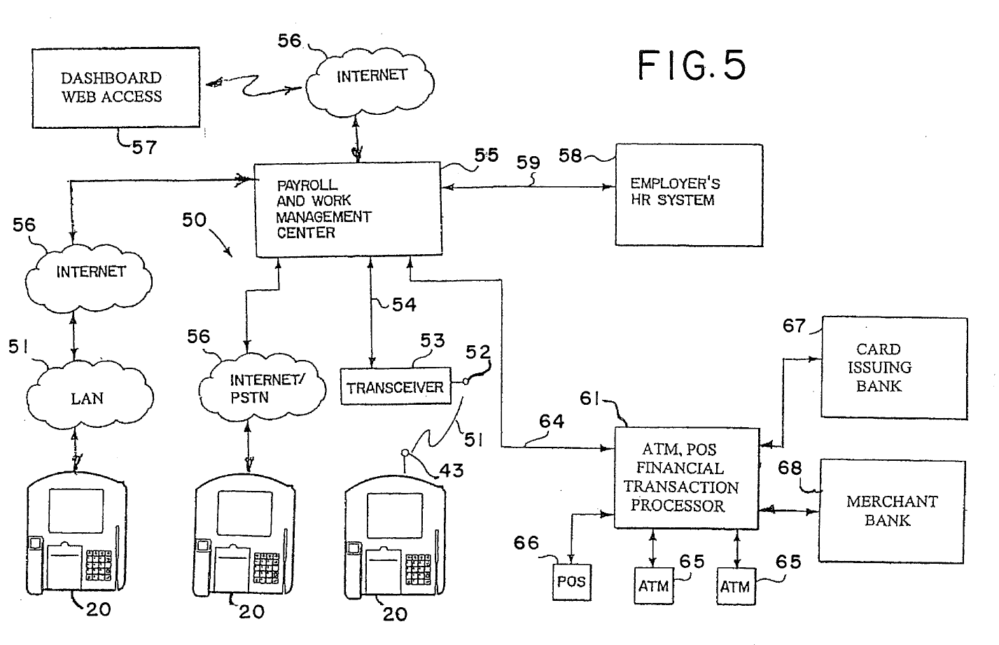

With reference to FIG. 4, there is shown an ATM, payroll and work management (APW) system, generally designated 50. One or more APW biometric terminals 20 are included in the APW system 50. One of the APW biometric terminals 20 is shown with an antenna 43 to transmit radio waves to the antenna 52 of a transceiver 53, which in turn communicates with a payroll and work management center 55 via one or more lines 54. While antennas 43 and 52 of APW biometric terminal 20 and transceiver 53, respectively, are shown as external for purposes of the illustration in FIG. 5, it will be appreciated that these antennas 43 and 52 could be internally disposed within the respective APW biometric terminals. The other APW biometric terminal 20 is shown communicating with center 55 via the internet or the PSTN 56. Yet another APW biometric terminal 20 communicates with center 55 via a LAN 51 and the internet 56.

The payroll and work management center 55 has a computer with memory for storing the names of employees, the pay rate for each employee, any deductions from pay for health insurance or the like, the number of the unique bankcard that has been assigned to each employee and the PIN associated with each bankcard. Payroll and work management center 55 may have additional pertinent information concerning each employee, such as a mailing address and a home telephone number. Center 55 previously received such information from the employer's human relations (HR) system 58 via a communication line 59. From time to time as new employees are hired, or when the status of an employee changes, employer's HR system 58 provides updated employee information to the payroll and work management center 55. Dashboard web access 57 enables real-time monitoring of the status the APW system, including information on employees that are registered on the system, the number of employees that have checked into work at any particular site, and the like.

Center 55 also records the time of check-in and the time of checkout for each employee to determine the amount of work time. The pay for each employee is calculated based upon the recorded work time and the pay rate for each employee. These calculations may occur as frequently as directed by the employer, such as each day or each week. Payroll and work management center 55 then advises the employer of the amount of the payroll. Center 55 then performs an electronic funds transfer (EFT) from employer's bank in the amount of the payroll so that each employee's bank account associated with each APW card will be credited in the net amount of pay for that pay period.

Payroll and work management center 55 may advise employer's HR system 58 on line 59, employer's bank 61 on line 63 and/or the ATM, POS financial transaction processor 61 on line 64 of the break-down of the payroll. Each employee with earnings in the respective pay period will have his/her account associated with the bankcard credited with the appropriate amount of net pay. Thereafter, the employee may access his/her available funds, such as by making cash withdrawals at an ATM 65. The APW card may also be used as a debit card against available funds at any point of sale (POS) 66, such as at department stores, grocery stores, gas stations or the like.

FIG. 5 illustrates a payroll and work management system, generally designated 60, similar to the system 50 illustrated in FIG. 4. However, in the system 60, there is no intermediate bank, such as employer's bank 69 in FIG. 5. Otherwise, the operation of the system 60 is generally similar to the already described operation of system 50.

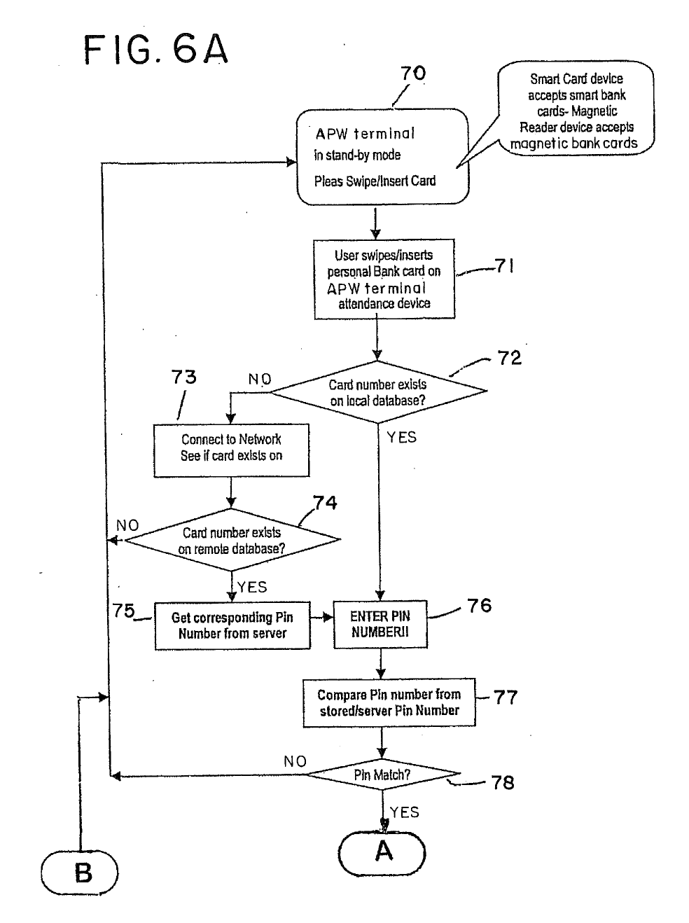

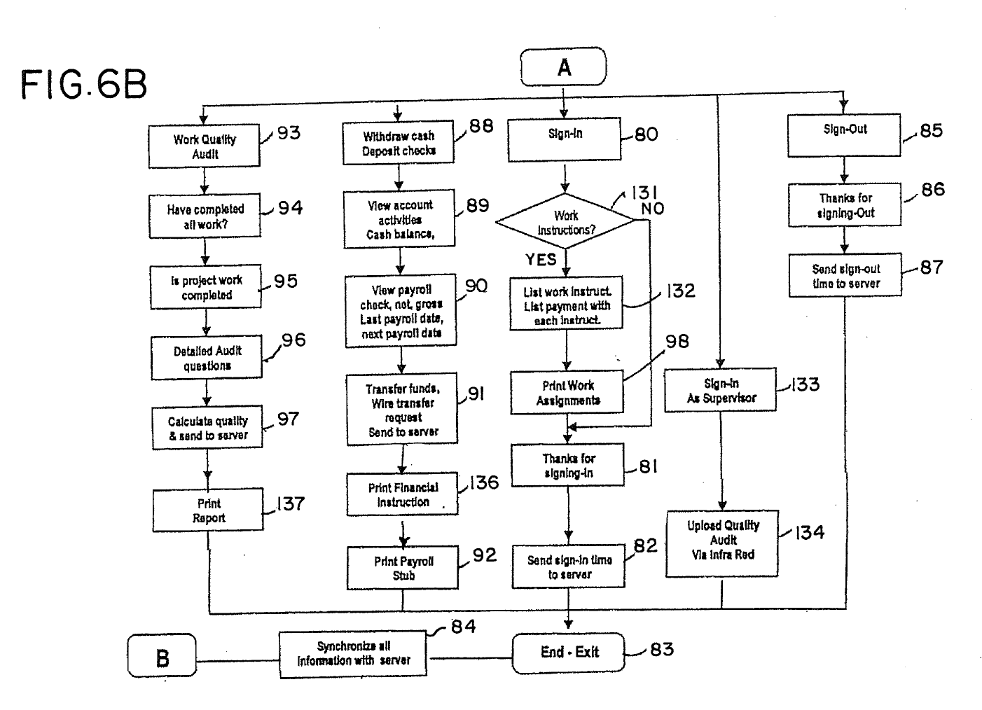

FIGS. 6A and 6B are flowcharts of the functions and communications between one or more APW biometric terminals 20 and the payroll and work management center 55. As seen in block 70, the APW biometric terminal 20 is initially in a stand-by mode and display 21 may display a request, such as “Please Swipe or Insert Card” or use the biometric reader 30. When the user swipes or inserts his/her card or enters a fingerprint on the fingerprint reader 30, the unique account number is read and transmitted, or the fingerprint data is read and transmitted, to the payroll and work management center 55, as indicated in block 71. Center 55 then searches to see if the card number or fingerprint data exists on its local database as shown in decision block 72. If not, center 55 may poll a remote network or database, such as that existing at the employer (block 73). If the card number or fingerprint data exists on a remote database, block 74, the center 55 will also obtain the corresponding PIN from the remote database, block 75. If the card number and PIN or fingerprint data are not available on remote databases, the APW biometric terminal 20 will return to the stand-by mode in block 70.

Assuming that the card number and PIN are available on the local or remote databases, APW biometric terminal 20 requests that the employee enter the PIN at block 76. The entered PIN is then compared to the stored PIN information in block 77. If there is no match, decision block 78 returns the APW biometric terminal 20 to the stand-by mode; block 70. If there is a PIN match at block 78, the authentication procedure is successfully completed and the employee continues to the various options shown in FIG. 6B. The process for handling fingerprint images is described in further detail in FIGS. 9A-9G.

Upon completing authentication, the employee may be presented with four options on the display screen 21, such as sign-in, sign-out, financial transactions and work related functions. The employee then uses the navigation keys to scroll to one of the desired functions displayed on screen 21, or enters the number of the desired option on keypad 25. If sign-in is selected, APW biometric terminal 20 acknowledges that the employee has signed in at block 80 in FIG. 6B. Block 131 determines if any work assignments or instructions were previously entered for this employee. If so, the work assignments and/or instructions are presented on the display 21 of APW biometric terminal 20 as indicated at block 132. Since there may be differences in pay for different types of work, the different pay rates are also displayed. The employee may then print out the assignments, instructions and pay rates from the APW biometric terminal 20. The time of sign-in is then sent to the computer at the payroll center, as indicated in block 82. Alternatively, the computer may simply receive the sign-in information and set the time of sign-in by using its own clock. The APW APW biometric terminal 20 then exits via block 83, synchronizes its data with that of the computer as shown in block 84 and returns to the stand-by block 70.

If the employee elects to sign-out of work after authentication, as at block 85, the APW biometric terminal 20 thanks the employee for signing out, as at block 86. The computer then stores the time of sign-out. The computer can then determine the amount of time worked by determining the amount of time between the times of signing in and signing out.

If the employee selects a financial transaction after the authentication procedure, several choices such as shown in blocks 88-92 in FIG. 6B may appear. If APW biometric terminal 20 is equipped for cash transactions, the employee may withdraw cash or deposit money into the bank account associated with the account number encoded on the APW card, as at block 88. If the choice illustrated in block 89 is selected, the employee may see the current balance in the bank account and may review recent account activities, such as within the last month. The employee may also view the last payroll payment credited into his/her account, the gross pay, the deductions from gross pay, the next payroll date, and so forth, as shown in block 90. The employee may also print this information by selecting the print payroll stub option at block 92. The employee may select to transfer funds to another account, such as a checking account, or to request a wire transfer as shown in block 91.

The employee may also select work related functions after authentication of the bankcard and PIN. Blocks 93-97 are reserved for a supervisor or customer to enter information about the performance of the employee that may affect the amount of pay. The employee may view this information, but not make new entries or change the existing information. However, if the employee frequently receives new work assignments, he/she may view the new work assignments or the new work location, as shown in block 98. The new assignments may also be printed out at APW biometric terminal 20, as shown at block 98.

A supervisor or customer may also sign in at APW biometric terminal 20 as indicated at block 133. A work quality audit may then be uploaded at the infrared port 35 of APW biometric terminal 20 as previously described, and as indicated at block 134. This is the report that the employee may view at blocks 93-96. The quality audit may result in adjustments to the employee's pay in accordance with prior arrangements or understandings between the employer and employee.

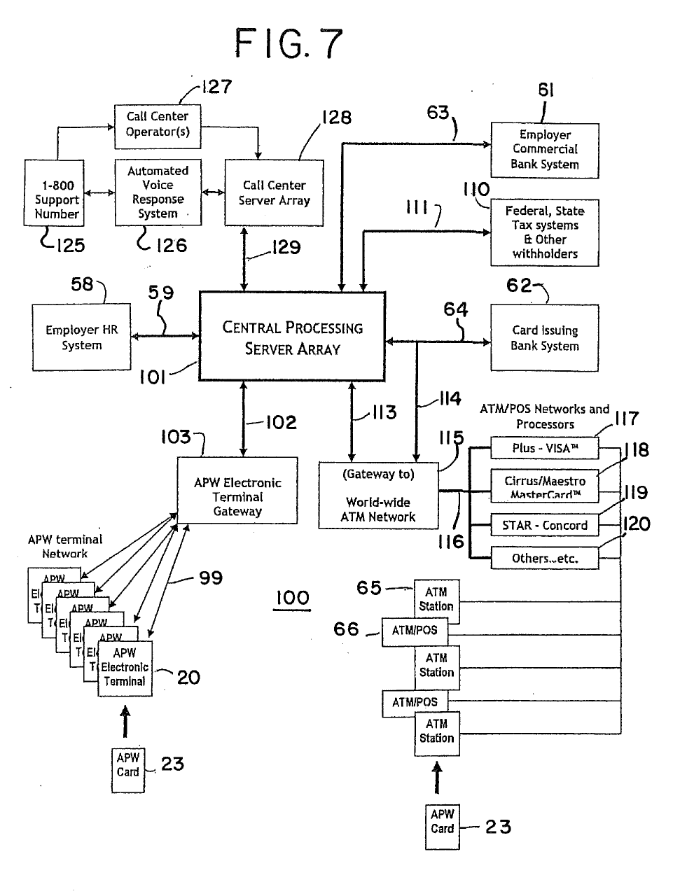

Illustrated in FIG. 7 is a payroll and work management system, generally designated 100. A plurality of APW biometric terminals 20 communicate via links 99, which may be via an internet or PSTN link 56 or a wireless link 51 (FIGS. 4 and 5) to an APW electronic APW biometric terminal gateway 103. Gateway 103 is equipped with modems and transceivers to receive the communications from the APW biometric terminals 20. Gateway 103 may also be equipped with a conventional firewall to protect a central processing server array 101 from unauthorized access. Information to and from APW biometric terminals 20 is communicated between the array 101 the gateway 103 via lines 102. Gateway 103 may be physically located near array 101 or gateway 103 may be located at an employer's site where it communicates with a plurality of APW APW biometric terminals 20.

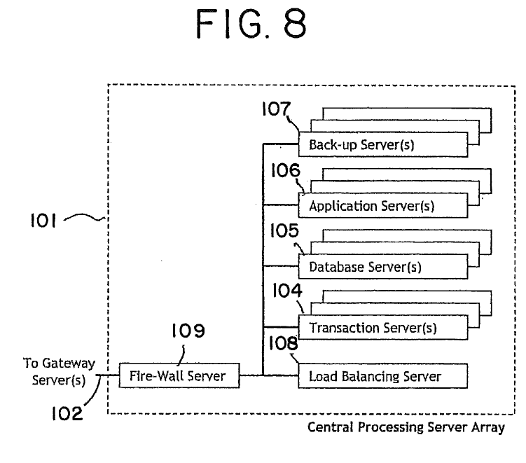

Central processing server array 101 is shown in greater detail in FIG. 8. Array 101 may typically consist of a plurality of servers, such as a plurality of transaction servers 104, a plurality of database servers 105, a plurality of application servers 106, a plurality of back-up servers 107 and a firewall server 109. Of course, the server array 101 can be implemented in a variety of other ways, such as with an Intel™-based computer, a Unix™-based computer, a mainframe computer or the like. Array 101 operates in general as a multi-purpose computer to receive, send, process and store information.

A plurality of server arrays 101 may be distributed in selected locations in a nationwide system, such as in Chicago, New York, Atlanta, Los Angeles, Denver and so forth. The APW biometric terminals 20 will then generally communicate with the nearest server. Preferably, back-up servers are also provided to prevent the loss of stored information and to provide continued processing services in case any one server array becomes non-functional.

The server array 101 operates substantially as already described with reference to FIGS. 4 and 5. Array 101 periodically communicates with the employer's HR system 58 to obtain updated employee information. After calculating a payroll, the array 101 issues electronic fund transfers (EFTs) to transfer funds from the employer's commercial bank 61 to the appropriate federal, state and local taxing authorities 110 for the withheld taxes, FICA and other applicable taxes. The array 101 records all transactions and is able to track the history of all payments.

Server array 101 also issues EFTs upon calculating the payroll from the employer's account at employer's bank 61 through a worldwide ATM network gateway 115. An electronic file containing the amount of the net pay to be credited to each employee's account is sent to the appropriate ATM network processor, such as Plus™ 117, Cirrus™ 118, STAR™ 119 or others 120. Thus, each APW card account is incremented with that employee's net pay. The server array 101 then contacts the appropriate card issuing bank, such as bank 62, to confirm the success of the EFT transfers, as by comparing the total deposit with the sum of all the individual employee net payments. If the EFTs were successful, each employee should have his/her account credited by the appropriate amount of net pay.

ATM networks and processors, such as Cirrus™/Maestro™ 118 owned by MasterCard™, PlUs™ 117 owned by VISA™ and Star™ 119 owned by Concord EFS™ are entities that own and link many ATM machines. These entities are in effect service providers for their respective ATM machines. These networks 117-120 have central processing systems that permit funds to be deposited to accounts such as those associated with each employee's APW card. Similarly, these processing systems of the networks 117-120 debit the cardholder's account if cash is withdrawn at an ATM 65 or a purchase is made at a POS 66, such as at a grocery store, gas station or the like. Typically, the POS 66 makes a modem connection with one of the networks and processors 117-120 to process an EFT in the amount of the purchase for credit to the appropriate merchant.

The payroll and work management system 100 also has a call center including a 1-800 support number 125, an automated voice response (AVE) system, one or more call center operators and a call center server array 128. Thus, an employee having difficulty with any APW terminal 20 may call the 1-800 number for help with a transaction, system status, payroll or balance inquiries or the like. Call center operators 127 may have a personal computer to access the central processing server arrays 101 via the call center server array 128 to obtain information about the inquiring employee's account by first logging into central processing server array 101. When using the AVR system 126 from a remote telephone, the inquiring employee uses the matrix of keys on the telephone to access the desired information by following the commands issued by the voice response system in a manner known to the art. The employee logs onto array 101 by entering the bank account number on the APW card and then entering the associated PIN or by use of the fingerprint reader 30, or a combination of both depending upon the desires of the employer. Alternatively, authentication may include the bankcard 23 or the fingerprint reader 30 in combination with an employee ID number.

It will be appreciated that any employee will have considerable reluctance to give even his/her best friend their APW card and PIN. This is because the friend will then be able to access that employee's bank account associated with the account number and the PIN. Even if the friend does not fraudulently withdraw funds from the bank account, the friend will be able to view recent account activity at the APW biometric terminal. Thus, the APW card and PIN operate very effectively to significantly reduce the buddy-punching problem. This may be nearly as effective as any known biometric system. On the other hand, some employers feel that a biometric device, such as fingerprint reader 30 offers better immunity to buddy punching because of the uniqueness of fingerprints.

The APW system also significantly reduces the expenses associated with the conventional activities of processing time sheets and then issuing and distributing checks. Moreover, the APW system readily provides available payroll funds without the expenses attendant to cashing payroll checks at an alternative financial service provider, and provides for more frequent payrolls, such as on a daily basis. It also provides an effective bank account for all employees. Employees may obtain a printed payroll stub at any APW biometric terminal, complete with details on the gross pay, deductions and net pay. Work assignments may also be available for viewing and printing at any APW biometric terminal.

FIGS. 9-24 illustrate screens that may appear on the display the various functions that may be available on APW biometric terminal 20 for use by employees and supervisors.

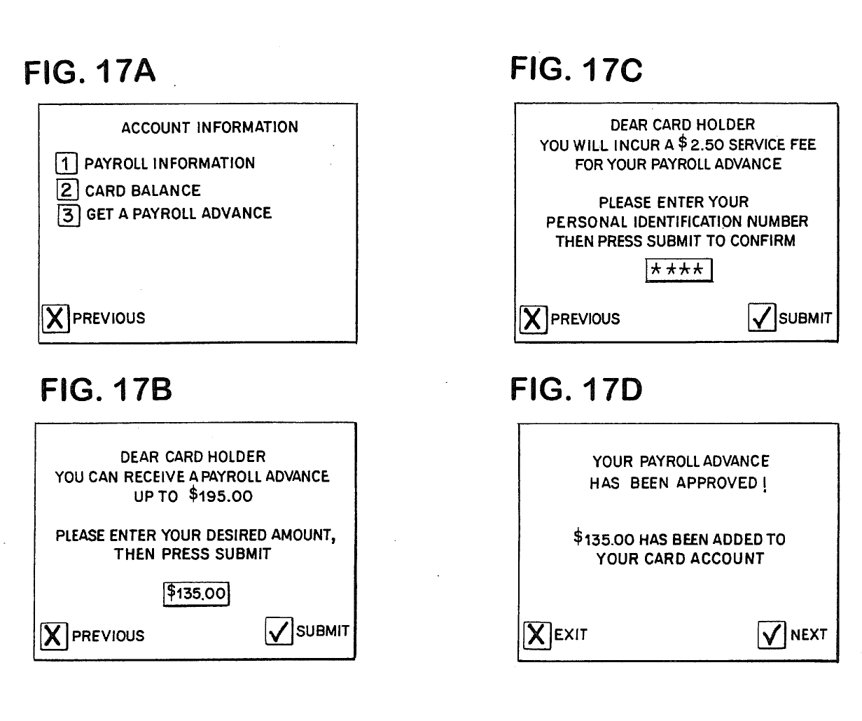

FIGS. 9A-9G illustrate typical screens that may appear on the display 21 of APW biometric terminal 20 during the authentication procedure, which must be satisfactorily performed prior to obtaining access of any of the other available functions on APW biometric terminal 20. The initial screen in FIG. 9A instructs the employee to place a finger on the fingerprint reader 30 of APW biometric terminal 20. Use of a left finger on fingerprint reader 30 is preferable since it keeps the right hand conveniently available for making entries on keyboard 25 or on touch-sensitive screen 21. Of course, if fingerprint reader 30 was disposed on the right side of APW biometric terminal 20, the opposite would be true, i.e., it would be preferable to read a right finger to keep the left hand available for keyboard or screen entries. When the employee is ready, he/she is instructed to actuate the fingerprint reader by touching the start button on the screen or by actuating the fingerprint reading key on the keyboard 25, as shown in FIG. 9B. APW biometric terminal 20 then compares the fingerprint from fingerprint reader 30 with fingerprints scans that were made when the employee was first registered on the APW system. The initial registration procedure, which captures images of the employee's fingerprints, is presented in greater detail below with reference to FIGS. 17A-17H. If the fingerprint reading is matched with a fingerprint on file, such as in a memory of APW biometric terminal 20 or in the APW system, the next screen to appear on APW biometric terminal 20 may be the screen in FIG. 9D requesting further information, such as an employee number, which may be a social security number, or requesting that the employee swipe his/her bankcard 23 in the slot of the bankcard reader 22. Note that in this example, the social security number or bankcard information is used to supplement the fingerprint identity, but some employers may be satisfied with only the use of the fingerprint verification or bankcard verification for purposes of check-in. Of course, if only bankcard verification is used for authentication on APW biometric terminal 20, the employee may also be directed to enter a personal identification number associated with the bankcard number. After entering the social security number or swiping the bankcard, the employee presses the check or accept key on keypad 25 or on screen 21 to continue as shown in FIG. 9D. If only fingerprint identity is used for punching in, the authentication process may skip to the screen of FIG. 9E in which the employee is welcomed by his/her name and provided with various options for further action such as checking in or checking out of work.

However, if APW biometric terminal 20 cannot match the fingerprint from reader 30 with a corresponding image on file, the screen of FIG. 9C will appear advising of the inability to match the fingerprint. Preferably, there will be a side-by-side comparison of the closest print on file and the currently read image. Orthogonally disposed crosshairs 31 may indicate that the employee placed his/her finger too high or too low, or too far to the left or right, compared with the file image. Preferably, the origin of the crosshairs 31 will coincide near the center of the fingerprint image. Thus, the side-by-side images will assist the employee in attempting to get better centrally located placement of his/her finger on the next reading attempt. The next reading attempt is initiated by the retry button on the screen in FIG. 9C or by again pressing the fingerprint read button on keypad 25 (FIG. 9B). Of course, if the additional employee information of FIG. 9 is available as alternative authentication information, the employee may elect to provide this information instead of continuing the fingerprint reading access to the system. Typically, after two or three unsuccessful attempts of fingerprint reading, the screen of FIG. 9F will appear advising the employee is advised that his/her supervisor will approve of the unmatched fingerprint images at a later time. The screen of FIG. 9G then appears to permit punching in or out of work. Since the employee failed in his/her attempts to properly pass the authentication steps, the screen of FIG. 9G does not provide the employee with access to any accounts associated with the bankcard, preferences or access to administrations as in the screen in FIG. 9E.

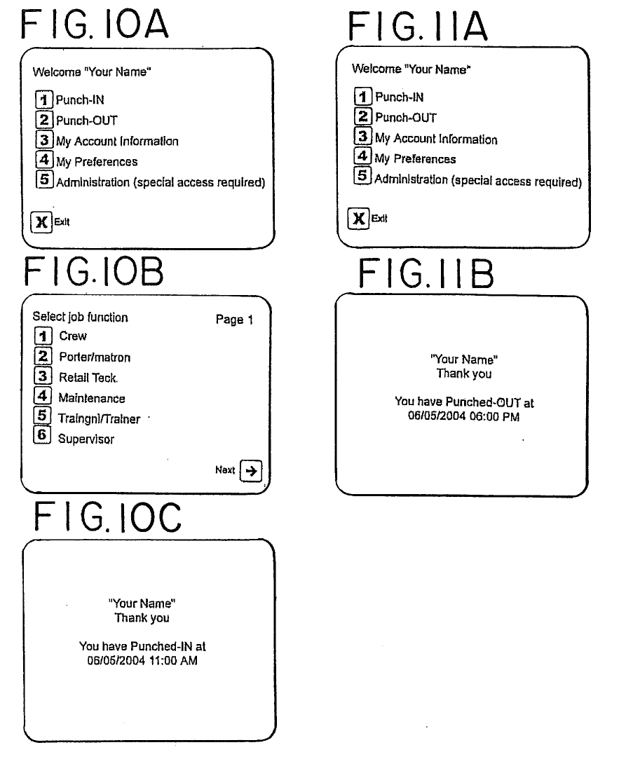

The punch-in procedure on APW biometric terminal 20 is shown in FIGS. 10R-10C. After successful authentication in FIGS. 9A-9E, the screen of FIG. 9E appeared. The screen in FIG. 9E is the same as the screen in FIG. 10R, which is the beginning of the punch-in procedure. This screen will be called the “main page” since it is the starting point after authentication and since it provides a menu of available functions for the employee to select from, including punch-in. Other available functions that can be selected include punch-out, account information, preferences and administration. These additional functions will be presented in further detail below.

The desired function is selected by touching the desired touch-sensitive button in the screen of FIG. 9E or by entering the associated number 1 on keyboard 25. After selecting to punch-in, the employee may be presented with a menu of job functions, such as that shown on the screen in FIG. 10B. Some employees may have potentially more than one job function and different rates of pay may apply to different job functions. The employee will select the appropriate job function for that day. Note that the employee may also change job functions during the same day by checking out and then rechecking in and entering a new job function for the next portion of the day, or for the remainder of the day. In the example of FIG. 10A, the employee selects the supervisor job function by pressing the numeral 6 on keypad 25 and then pressing the “next” key, which is also the right arrow key on keypad 25. However, pressing the next key before selecting any job functions displayed on the screen shown in FIG. 10B may provide additional job function choices. After selecting a job function in FIG. 10B, the screen in FIG. 10C confirms that the employee has successfully checked in and displays the time of check-in.

The punch-out procedure is shown in FIGS. 11A and 11B and begins with the main page of FIG. 11A. Punching out is initiated by touching the second listed item in FIG. 11A or by pressing the 2 key on keypad 25. The screen of FIG. 11B appears, which identifies the employee by name and confirms the time and date of punching out.

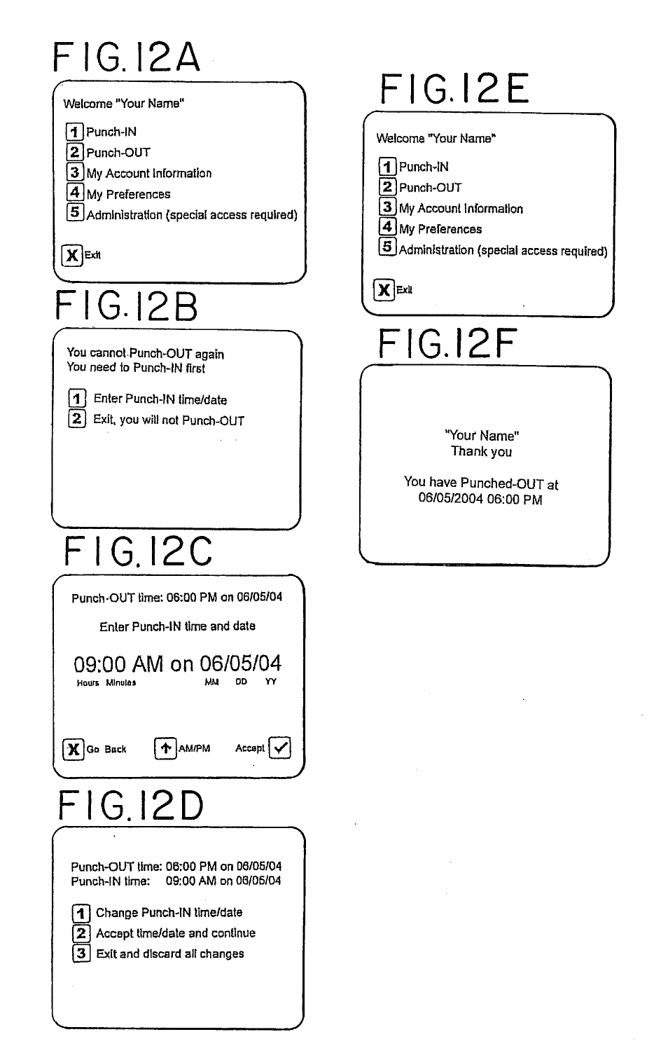

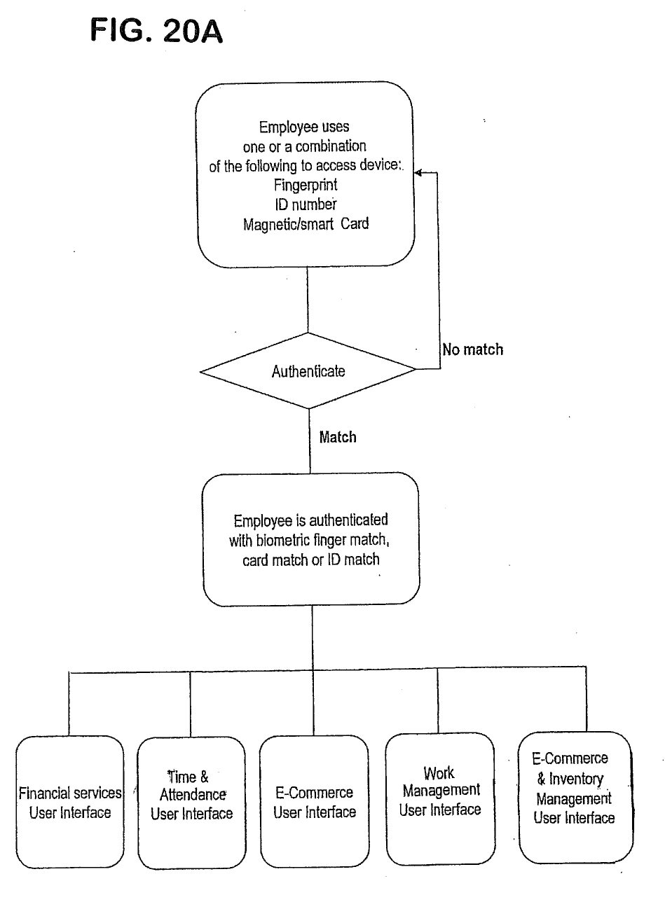

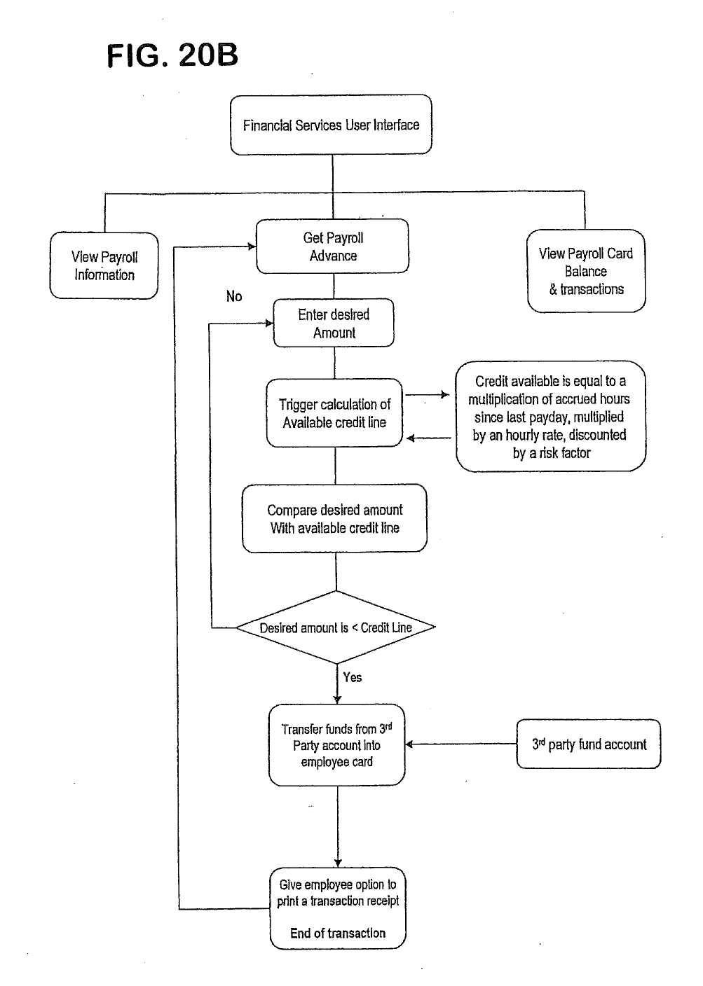

Occasionally, an employ may fail to punch-in for work because he/she forgot, was distracted, or the like. The procedure shown in FIGS. 12A-12F enables the employee to supply the missing punch-in time when he/she punches out. In the example of FIGS. 12A-12F, the employee is first responsible for entering the missed punch-in time. The supervisor will later review the employee's entries for the missed punch in and either approve them as entered or edit them in accordance with FIGS. 20A-20H. After authentication and presentation of the main page in FIG. 12A, if the employee tries to punch-out with a missed punch-in, the employee is advised in the screen of FIG. 12B that he/she cannot punch-out again before first punching-in. The screen in FIG. 12B invites the employee to select the first option by pressing the numeral 1 key to manually enter his/her missed punch-in time. The screen of FIG. 12C then appears and enables the employee via keypad 25 to enter the punch-in time and date, as well as the AM/PM designation with the up/down arrow keys. Pressing the accept or check key will save the entered data relating to the missed check-in time. The screen in FIG. 12D then displays the entered punch-in time plus the current punch-out time. Further editing of the data is permitted by pressing the numeral 1 key, acceptance of the data occurs if the numeral 2 key is pressed, or the entered data is discarded if the numeral 3 key is pressed. If key 2 is pressed to accept the times shown, the employee is thanked at the screen of FIG. 12F.

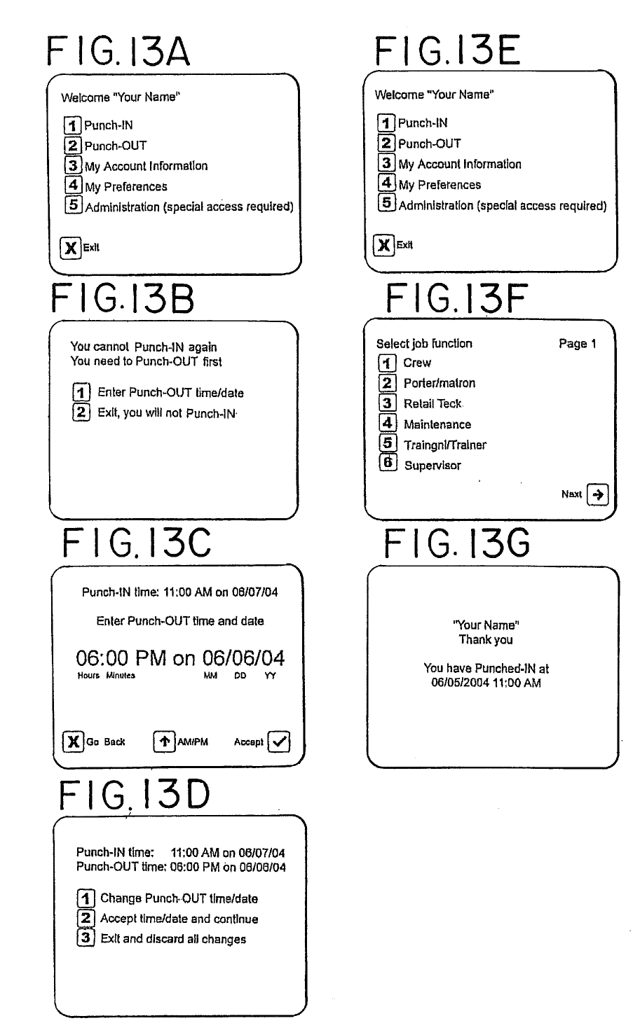

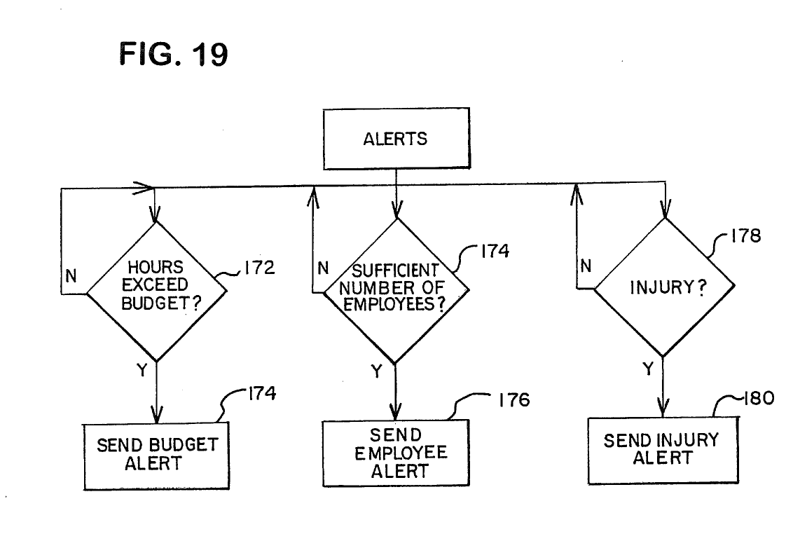

A similar procedure enables the employee to supply any missing punch-out time. This procedure shown in FIGS. 13A-13G enables the employee to supply the missing punch-out time when he/she next attempts to punch-in. In the example of FIGS. 13A-13G, the employee is first responsible for entering the missed punch-out time. The supervisor will later review the employee's entries for the missed punch-out and either approve them as entered or edit them in accordance with FIGS. 19A-19E, as described below. After authentication and presentation of the main page in FIG. 13A, if the employee tries to punch-in with a missed punch-out, the employee is advised in the screen of FIG. 13B that he/she cannot punch-in again before first punching-out. The screen in FIG. 13B invites the employee to select the first option by pressing the numeral 1 key to manually enter his/her missed punch-out time. The screen of FIG. 13C then appears and enables the employee via keypad 25 to enter the missing punch-out time and date, as well as the AM/PM designation with the up/down arrow keys. Pressing the accept or check key will save the entered data relating to the missing punch-out time. The screen in FIG. 13D then displays the entered punch-out time plus the current punch-in time. Further editing of the data is permitted by pressing the numeral 1 key, acceptance of the data occurs if the numeral 2 key is pressed, or the entered data is discarded if the numeral 3 key is pressed. If key 2 is pressed to accept the times shown, the employee is prompted at the screen in FIG. 13F to select the appropriate job function upon checking-in. The employee is then thanked at the screen of FIG. 13G, including confirmation of the current check-in time.

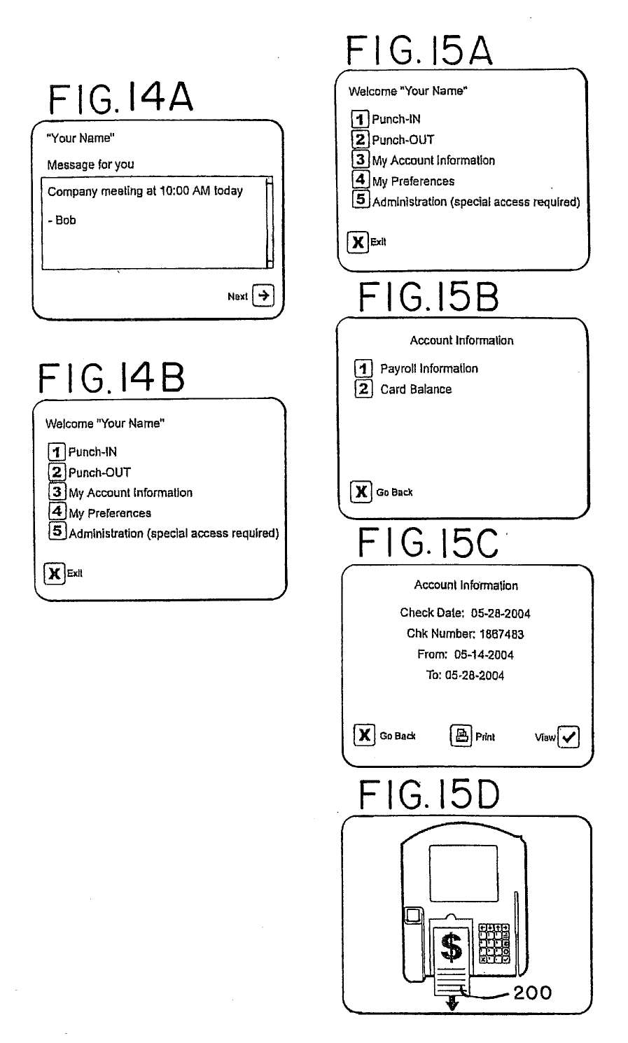

FIGS. 14A-B are concerned with reviewing and printing any messages. After employee authentication, any message, such as that displayed in FIG. 14A will appear before the main screen appears. The content of the messages can vary significantly, such as that of a scheduled meeting in FIG. 14A, the need to call someone, a changed work assignment, a changed work location, an additional work assignment, a request to accept a different job function for the day, or the like. The employee may press the print key shown on keypad 25 in FIG. 98 (above the fingerprint activation key) to print a copy of the message. Pressing of the next or right arrow key in FIG. 14A will take the employee to the main screen of FIG. 14B. The employee can then select one of the main menu options or exit the APW biometric terminal 20.

FIGS. 15A-D show the steps utilized to review payroll information and to print a payroll stub. After system authentication of the employee, the employee enters the numeral 3 key on the keypad in FIG. 15A to access My Account Information. In FIG. 15B, the employee enters the numeral 1 key to access payroll information. The screen in FIG. 15C will appear showing the check reference number, the pay period and the date of the check or payment to the bankcard. If the print key on keypad 25 is pressed, a payroll stub 200 will be printed from APW biometric terminal 20 as shown in FIG. 15D.

A universal payroll stub format should be suitable to send, receive, display, deliver and print any type of payroll stub over the following media:
The All purpose ATM device
Over the web
Over the phone via an Integrated Voice Response (IVR) system
   One of the main problems in printing a universal stub is the ability to send, receive and print multiple employees and multiple employer payroll information. For example some employees might be enrolled in a 401K program, while others have to pay alimony. Some employers offer a payroll deduction credit for a specific health or benefit program while others don't. We've developed an infrastructure and communication methodology which handles, delivers, displays and prints, any type of payroll stub information. Our universal payroll stub infrastructure id designed using the following format:
Prior to sending and/or receiving a payroll stub to a device, web or IVR system, the employer must send us a template header record infrastructure detailing the general display of the pay stub. Such a template would contain records such as (1) GROSS PAY, (2) DEDUCTIONS, (3) TAXES (4) NET INCOME. From now on, any record received from the employer would be classified using the employer's record schema
Then, every payroll stub record must contain the point to the employer's template schema file. For example to show that Joe Crew has $1,000 in Wages for this pay period, and $5,000 in Wages Year-To-Date (YTD); and that he received $100 in bonus pay for this pay period and $300 in total YTD bonus pay. The employer would send the information in the following structure:
   “1”, “Wages”, 1000, 5000
   “1”, “Bonus Pay”, 100, 300
This automatically generates payroll stub information in the following format:

GROSS PAY

| | Current | Year to Date |
|---|---|---|
| Wages | $1,000.00 | $5,000.00 |
| Bonus Pay | $100.00 | $300.00 |

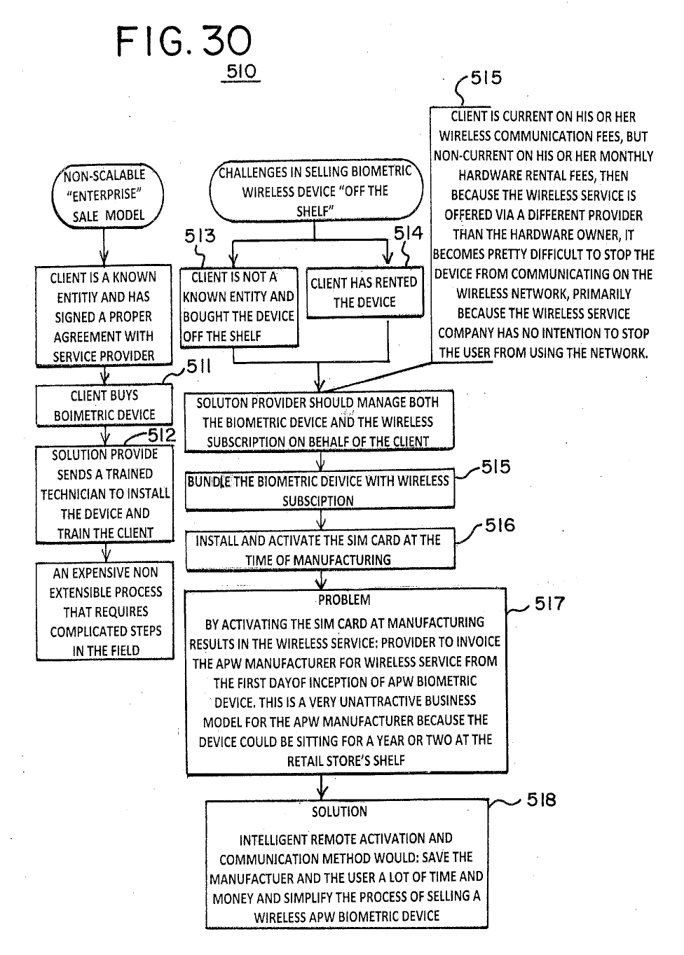

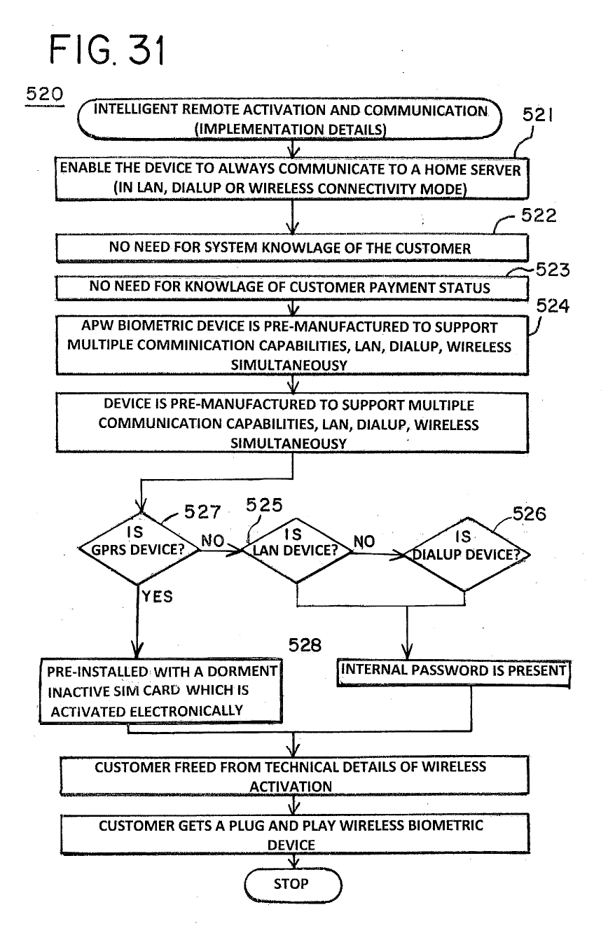

According to many state labor regulations, employer must give en employee a physical printout of his/her payroll stub on pay day at the location of work. Although many employers offer their employees direct deposit and give them access to electronic payroll stubs via secure internet, this approach is not feasible for a low wage employee, who usually does not have access to a PC or the internet. As a result, from an employer's perspective electronic payroll to a low wage employee is a losing proposition. This is because, even though, the employer is saving cost from mailing a physical paper check to a remote low wage employee, the employer still has to mail a physical paper pay stub to the employee in order to comply with state labor regulations. If this is the case, then the employer might as well send a paper paycheck with a paper pay stub and avoid the hassles of integrating electronic payroll with mailing a paper paystub to all low wage labor locations. Using the all purpose biometric device, upon accessing the system, and if today is payday, the employee is prompted to print his/her paystub. See, the flow chart of FIG. 30 for further details. This approach gives employers compliance with state and federal labor laws, this is because:
a. Employee was paid on pay day via electronic payroll deposit (on payroll card)
b. Employee was presented with a payroll stub at work location. Employer has a record that the employee decided to either print or not print his/her payroll stub on payday, at the work location.

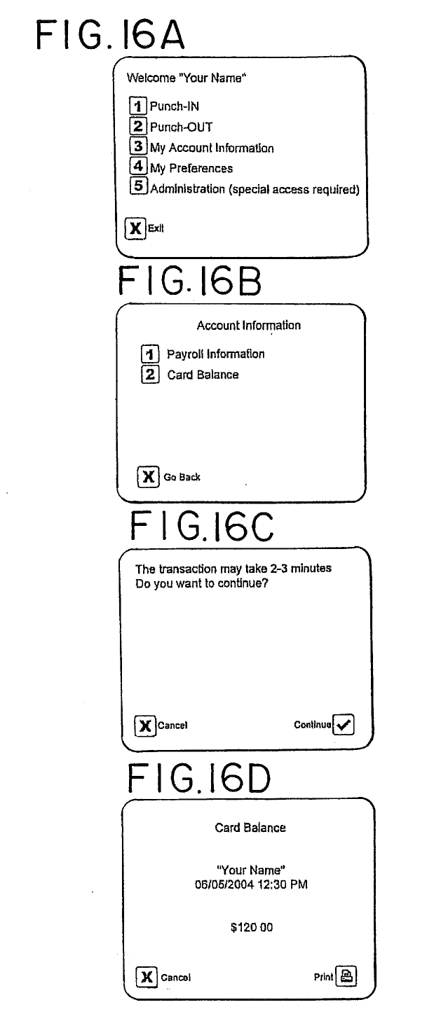

FIGS. 16A-D illustrate the steps used for viewing and printing the current balance remaining on the bankcard 23. After correctly authenticating with the system, the employee is welcomed at the main screen shown in FIG. 16A. If the employee selects the My Account Information by pressing the numeral 3 key on keypad 25. the screen shown in FIG. 16B will then appear. To review the balance on the bankcard, the employee presses the numeral 2 key on the keypad to select “Card Balances”. The employee is advised in FIG. 16C that there may be a short delay in retrieving the requested information and he/she is requested to press the check button on the keypad to continue. If the employee elects to continue, a short time later, a screen similar to that in FIG. 16D appears, advising the employee of the balance then remaining on the bankcard. The employee may then print the balance in the bankcard account by pressing the printer key on the keypad 25 (FIG. 9B). Whether the screen of FIG. 14D is printed or not, if the employee presses the cancel button on the keypad, the screen returns the Account Information screen of FIG. 16B. Entering the go back or cancel button again will return the employee to the main screen of FIG. 16A, where the employee may select additional options, including punch-in and punch-out or selecting exit. If the employee does not return to the main screen of FIG. 16A, the APW biometric terminal 20 will automatically revert to the starting screen after a predetermined time of inactivity.

FIGS. 17A-17D illustrate the steps for obtaining a payroll advance against currently accrued pay based upon the hours worked to date. After authenticating and selecting My Account Information on the main screen, the employee may be presented with the options shown in FIG. 17A, including “Get a Payroll Advance”. When this option is selected by pressing the numeral 3 key on keypad 25, the APW system calculates the amount of credit that is available for this particular employee, such as by multiplying the accrued hours worked since the last payday and the employee's hourly compensation rate. This amount is then discounted by a risk factor that includes at least the amount of pay that is deducted for taxes and any other applicable deductions from gross pay. For example, in FIG. 17B, the employee may be notified of the maximum amount of payroll advance that is available. The employee is then prompted to enter the amount of payroll advance that is desired. After pressing the check key to submit the payroll advance request, a screen shown in FIG. 17C may appear advising the employee of service charge applicable to the payroll advance transaction. Some further identification to complete this transaction may also be requested such as a PIN number associated with the employee's bankcard. Upon submitting the PIN, a screen shown in FIG. 17D appears showing that the payroll advance has been approved and that the requested amount has been credited to the employee's bankcard account. The employee may print the screen of FIG. 17D by pressing the print key on keypad 25 (FIG. 9B) or go to the employee's card balance option in FIGS. 16A-16D to confirm that the payroll advance has been credited to his/her account and print the current balance from the screen in FIG. 16D.

A substantial problem in distributed labor management is inability to communicate with field force and inability to get immediate feedback from the work site. The APW system gives managers the ability to log into a secure web page, type a message and select a set of canned answers to be displayed to their remote employees. For example, the manager could write a quick message saying “Joe, please clean aisle 3 immediately after you punch in”, then select (1) “Yes, consider it done”, (2) “Can't”, (3) “I need further detail”, as the canned answers or responses for the work request. The manager would then press a button and the message, plus the canned responses are sent to the appropriate APW biometric terminal 20. Upon punching-in at his work site, Joe is presented with the message sent from his manager, “Joe, please clean aisle 3 immediately after you punch-in”. He would then respond to the message using one of the 3 three given options: (1) “Yes, consider it done”, (2) “Can't, (3) “I need further detail”. Thus, Joe's supervisor quickly determines whether this additional task will be completed by Joe, or whether additional resources are needed to complete the task.

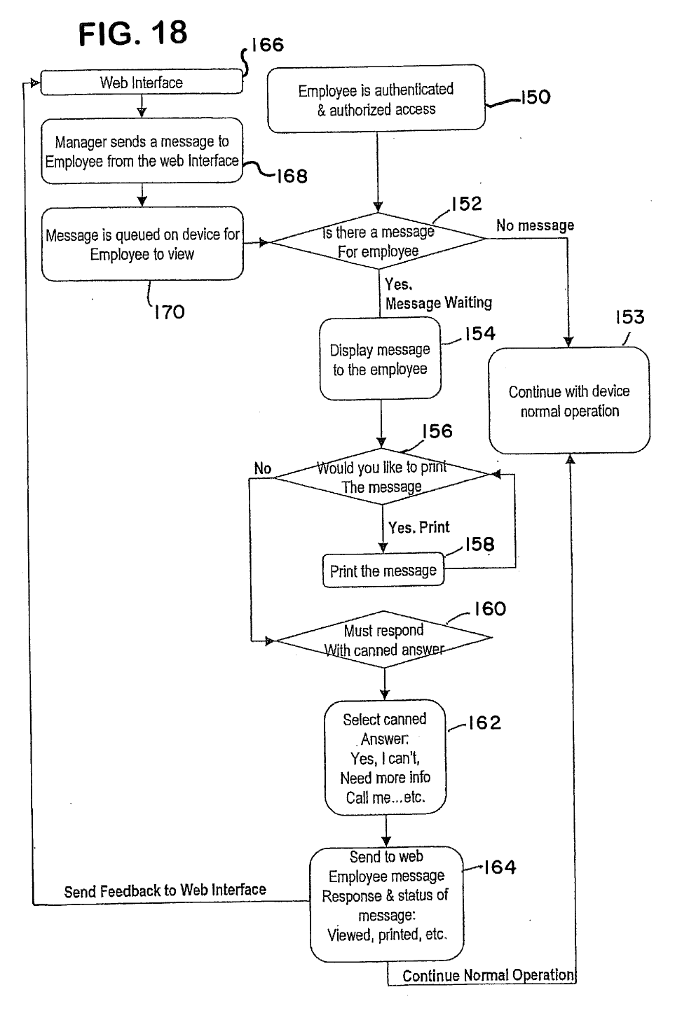

The flow chart in FIG. 18 illustrates these steps in greater detail. A supervisor or manager may create and send a message at block 168, which is then sent to and queued on the APW biometric terminal 20 that the employee will check-in on, at block 170. After authentication in block 150, if there is a message for the employee (block 152), the message is displayed (block 154). If there is no message at block 152, normal operation of APW biometric terminal 20 proceeds at block 153. At block 156, the employee is invited to print the message and the message is printed at block 158, if so selected. The process then moves to block 160 which requires a response to the message, such as with canned answers. The employee selects the desired response at block 162, which is then sent via the internet or web to the individual who sent the message; typically a supervisor of the employee. A supervisor or manager may create and send a message at block 168, which is then sent to the APW biometric terminal that the employee will check-in on, at block 170. The message is then ready for viewing upon authentication at block 152.

The APW system is also capable of providing a number of different kinds of alerts, such as those shown in FIG. 19. A substantial problem in distributed labor management is inability to manage thousands of employees, their hours and having ability to complete the work within allocated budgeted hours and budgeted dollars. As employees punch-in and punch-out, the system accumulates the amount of hours billed to a specific work location, job code or department code. When the number of hours exceeds a pre-set budgeted hour value (block 172 in FIG. 19), within a specific time-span (such as daily, weekly, bi-weekly or monthly budget), the system automatically alerts a manager or a hierarchy of managers (block 174) notifying them that hours budgeted have been exceeded. The same logic is true if the budgets were an amount in dollars, thus an alert is generated if the dollars spent at the work site, job code or department code have exceeded a budgeted dollar value. Alerts are generated from the local device, then routed via a central system and are delivered to individuals via email, text message, automated fax or automated text to speech synthesizer calling the alert recipient.

Another problem in distributed labor environment is the inability of the service provider to easily manage and track thousands of field employees and make sure that key employees are available and reporting to perform key tasks at customer sites. The system features an ability to notify a single manager or a hierarchy of managers if a single employee, or a set of employees are not present at a work site prior to predetermined time deadline. For example, the system generates an alert notification if a specific employee is not present by 8:00 AM to fix a burnt light bulb. Another example is that the system generates an alert notification if by 8:00 AM, only four out of the expected six cleaning employees are present at the customer's site, such as at block 174 in FIG. 19. Alerts are generated from the local device (block 176), then routed via a central system and are delivered to individuals via email, text message, automated fax or automated text to speech synthesizer calling the alert recipient.

The APW system can also accommodate miscellaneous alerts. For example, these alerts may be generated by an authorized employee using the system from an APW biometric terminal 20. An authorized employee accesses the system, then uses the user interface at the APW biometric terminal to initiate an alert, which is then routed to the appropriate manager or hierarchy of managers. For example, on his or her punch-out, the system may ask the employee if he/she had any accident today, such as at block 178 of FIG. 19. If the employee selects “No”, then he/she punches out and no alert issues. If the employee answers “Yes”, then an alert is immediately routed (block 180) to the appropriate manager who may need to investigate the issue further.

A substantial problem in distributed labor management is inability to communicate with field force and inability to get immediate feedback from the work site. The APW system gives managers the ability to log into a secure web page, type a message and select a set of canned answers to be displayed to their remote employees. For example, the manager could write a quick message saying “Joe, please clean aisle 3 immediately after you punch in”, then select (1) “Yes, consider it done”, (2) “Can't”, (3) “I need further detail”, as the canned answers or responses for the work request. The manager would then press a button and the message, plus the canned responses are sent to the appropriate APW biometric terminal 20. Upon punching-in at his work site, Joe is presented with the message sent from his manager, “Joe, please clean aisle 3 immediately after you punch-in”. He would then respond to the message using one of the 3 three given options: (1) “Yes, consider it done”, (2) “Can't, (3) “I need further detail”. Thus, Joe's supervisor quickly determines whether this additional task will be completed by Joe, or whether additional resources are needed to complete the task.

The flow chart in FIG. 18 illustrates these steps in greater detail. A supervisor or manager may create and send a message at block 168, which is then sent to and queued on the APW biometric terminal 20 that the employee will check-in on, at block 170. After authentication in block 150, if there is a message for the employee (block 152), the message is displayed (block 154). If there is no message at block 152, normal operation of APW biometric terminal 20 proceeds at block 153. At block 156, the employee is invited to print the message and the message is printed at block 153, if so selected. The process then moves to block 160 which requires a response to the message, such as with canned answers. The employee selects the desired response at block 162, which is then sent via the internet or web to the individual who sent the message; typically a supervisor of the employee. A supervisor or manager may create and send a message at block 168, which is then sent to the APW biometric terminal that the employee will check-in on, at block 170. The message is then ready for viewing upon authentication at block 152.

In some of the foregoing examples of the implementation of various functions with APW biometric terminal 20, the keypad 25 was used to enter the selected choice on the various menus and to navigate from one screen to the next, or the like. Of course, display 21 may be a touch-sensitive display that automatically selects the option that is touched on the screen, rather than requiring entry of an associated key on keypad 25 to initiate the desired function or screen.

FIGS. 20A and 20B are a flow chart of typical steps involved in calculating and approving a payroll advance, and are self-explanatory.

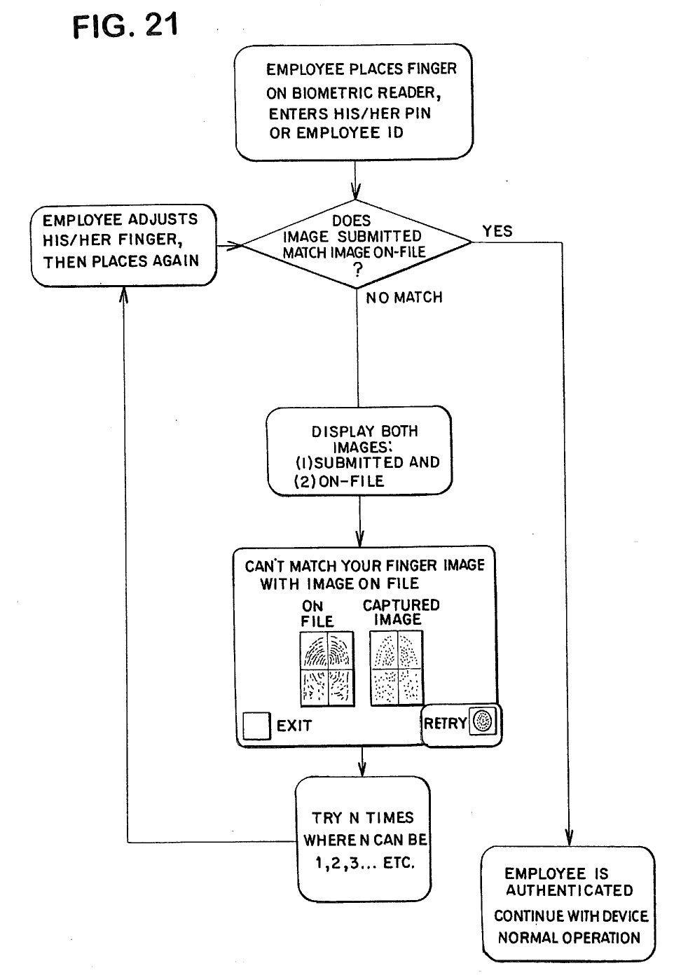

FIG. 21 is a flow chart of typical steps involved in authenticating with the fingerprint reader, and is self-explanatory.

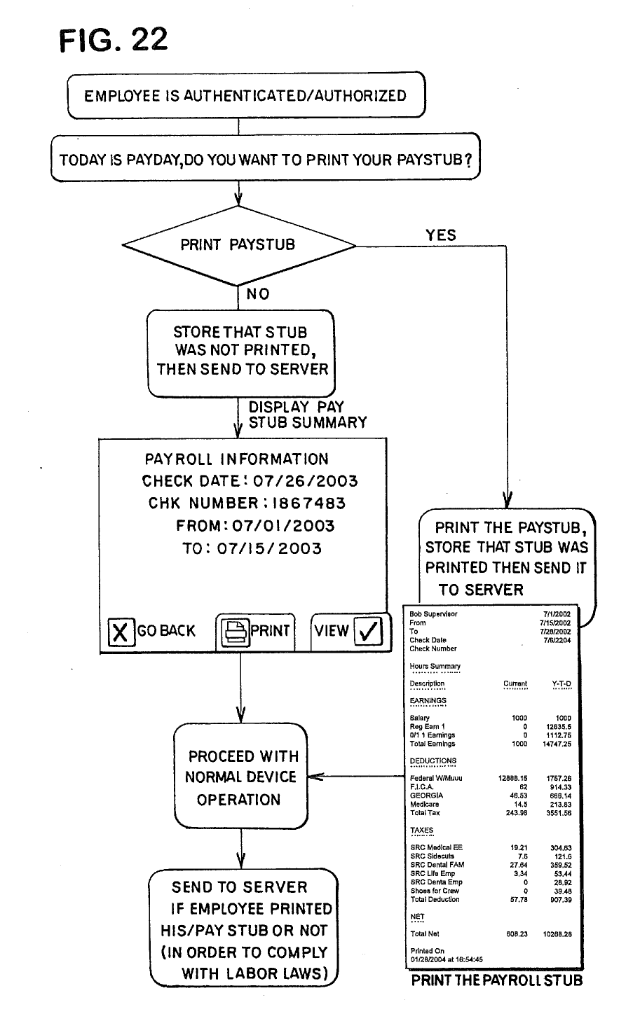

FIG. 22 is a flow chart of typical steps involved in printing a payroll stub from an electronic APW biometric terminal, and is self-explanatory.

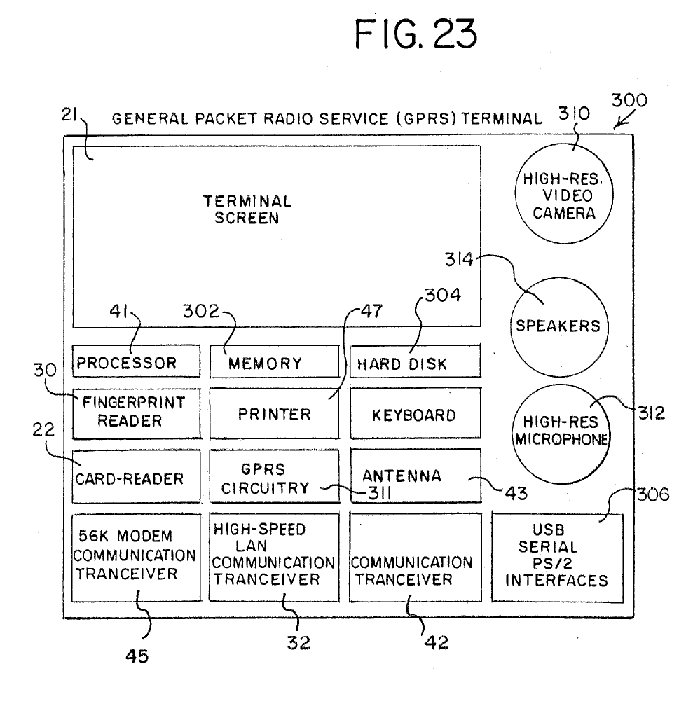

FIG. 23 illustrates a biometric electronic multi-purpose APW biometric terminal 300 in accordance with the present invention. Like APW biometric terminal 20 shown in FIGS. 1 and 3, APW biometric terminal 300 has a screen 21 for displaying information to an employee or other user, including any managers or the like. APW biometric terminal 300 also has a fingerprint reader 30 for obtaining data concerning a fingerprint pattern of a person. APW biometric terminal 30 may also be equipped with a card reader 22 for reading magnetic data on a bank card, and a keypad for entering numeric information, such as a personal ID (PIN) number, or for navigating through various options displayed on screen 21. As previously shown in FIG. 5 with respect to APW biometric terminal 20, APW biometric terminal 300 may also have a modem 45 for accessing the internet 56, a LAN transceiver 32 for communicating with a local area network which may also access the internet, and a wireless transceiver 42 for communicating via an antenna 43 with a remote transceiver 53, such as for a payroll and work management system. APW biometric terminal 300 is also preferably equipped with memory 302 for locally storing information, a hard drive 304 for additional data storage, and a plurality of ports, such as USB, serial and PS/2 interfaces 306.

APW biometric terminal 300 provides for a second opinion methodology in the event that the primary biometric test, such as with fingerprint reader 30, fails or is inconclusive. To this end, APW biometric terminal 300 includes a high resolution video camera 310 that captures live video and/or still pictures, and a high resolution microphone 312 which captures person's voice and sound waves. A speaker 314 may be used to direct the person standing in front of the biometric device to follow a set of live or pre-recorded instructions in order to obtain the images with camera 310 or a voice recording with microphone 312.

The system captures additional biometric information from the user standing in front of the APW biometric terminal, such as video, still picture, and/or voice files. Then, these files are passed on to the local APW biometric terminal 300, to a networked server, such as to server 101 in FIG. 7, or to a human (local human or remote human) that uses the second set of biometric information to make a (1) match, or (2) no match decision.

Preferably, APW biometric terminal 300 utilizes the General Packet Radio Service (GPRS) signaling protocol. For example, APW biometric terminal 300 preferably includes GPRS circuitry 311 to encode communications from the APW biometric terminal to the payroll system in accordance with GPRS protocol and to decode communications from the payroll system to the APW biometric terminal in accordance with GPRS protocol. The term “GPRS circuitry” means specific circuitry to accommodate and accomplish GPRS communication functions and/or software instructions executed by a microprocessor to accommodate and accomplish GPRS communication functions. GPRS is a wireless communication standard which provides up to 115 kilobits per second, compared to current GSM (Global System for Mobile Communications) which provides only 9.6 kilobits per second. Thus, GPRS, in theory, offers about ten times the data speed as compared to GSM. However, more typically encountered GPRS data transfer rates may be about 30 to 50 kilobits per second. GPRS supports a wide range of bandwidths and is particularly suited for sending and receiving both small bursts of data as well as large volumes of data. GPRS is available on most GSM networks. GPRS enables the use of packet-based data transfer over existing circuit-switched GSM networks, which allows greater efficiency in the radio spectrum because the radio bandwidth is used only when packets are sent or received. Of course, sending data wirelessly by GPRS signaling is more efficient and less costly than using a dedicated telephone line, such as sending data from an APW biometric terminal through a data modem to a public switched telephone network (PSTN). For remote locations where a telephone line may not be readily available, an APW biometric terminal 300 with wireless GPRS capability is also an ideal solution.

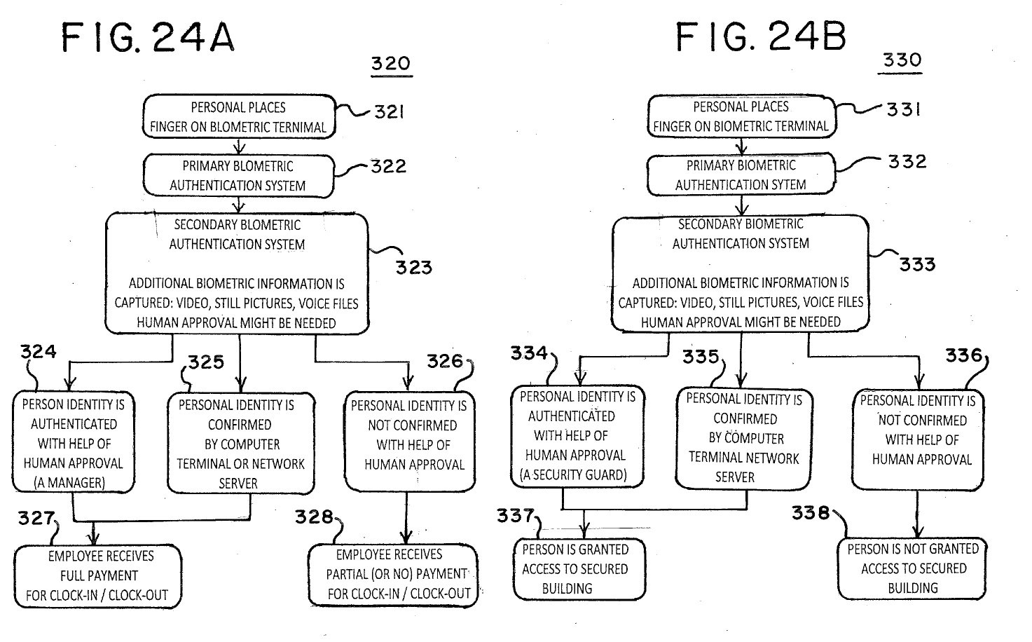

FIGS. 24A and 24B are flowcharts illustrating the steps employed by the electronic APW biometric terminal 300 shown in FIG. 23 in providing a second opinion to authenticate an employee or to permit a person to have access to a secure building, respectively. In block 321, the person or employee places his/her finger on the fingerprint reader 30 of APW biometric terminal 300. At block 322, the fingerprint data is gathered as the primary means of authenticating the person. Secondary biometric information is gathered at block 323, such as a video file or picture file via camera 310 or an audio file via microphone 312. If the primary biometric information does not provide a match with corresponding biometric information available in the system, APW biometric terminal 30 or the system will attempt to obtain a match with the secondary biometric information. If a match occurs with either the primary or secondary information at block 325, the employee receives full payment and is permitted to clock in and clock out at APW biometric terminal 300.

If no matches occur as a result of the primary or secondary biometric information, a human, such as a manager, may receive a message to review the information available from APW biometric terminal 300. If approved by the manager at block 324, the employee receives full pay at block 327 and the time of the clock in or clock out is recorded within the system. However, if the human intervention does not confirm identity of the employee at block 326, the employee may receive partial or no pay at block 328 until the discrepancy is resolved. However, the employee may still be allowed to clock in since there may not be a temporary or replacement employee immediately available at the time.

Blocks 331-336 in flowchart 330 of FIG. 24B bear close resemblance to blocks 321-326 in flowchart 320 of FIG. 24A. However, the result of the comparisons of the primary and secondary biometric information is to permit a person to have access to a building at block 337 or not to grant access at block 338.

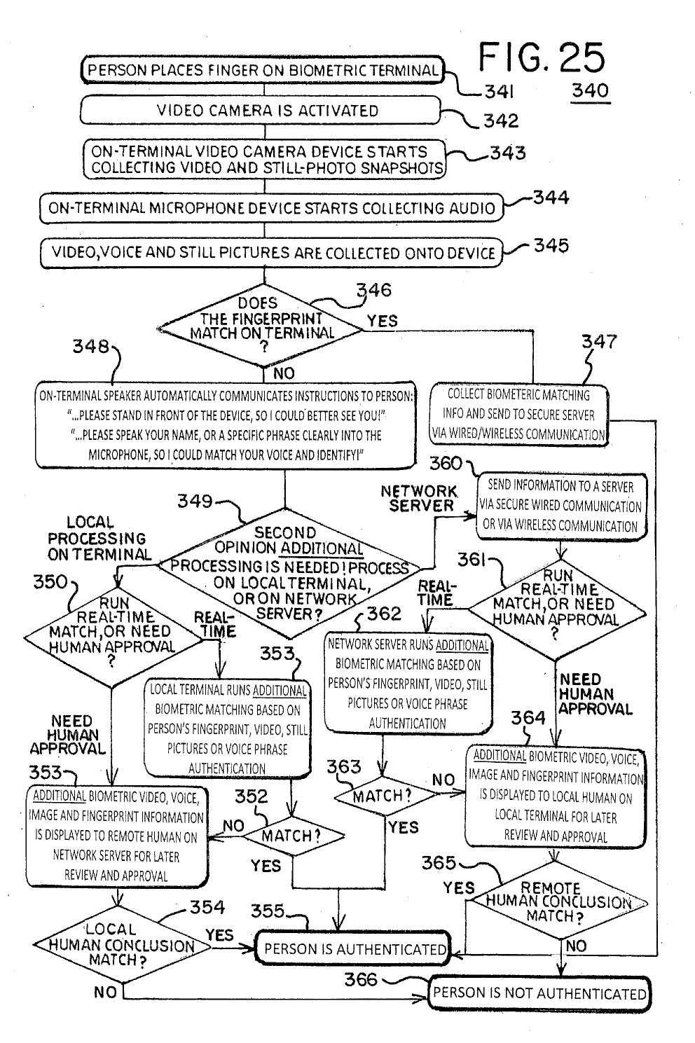

A flowchart 340 in FIG. 25 illustrates in the process of utilizing a secondary type of biometric information to authenticate a person. The process is initiated at block 341 by the person placing a finger on the fingerprint reader 30. At block 342, the video camera 310 may be initiated and a video file and/or a picture file may be collected at block 343. Similarly, the microphone 312 may begin collecting a voice file at block 344. These files may be collected at APW biometric terminal 300 at block 345. At block 346, a determination is made concerning whether a match is made for the primary type of biometric information. If a match is determined, the matching information may be forwarded by APW biometric terminal 300 to a server, such as server 101 at block 347 and the person is authenticated at block 355.

If a match was not determined at block 346 on the basis of the primary biometric information, the person may be instructed at block 348 to speak one or more phrases to provide voice files to microphone 312 for further comparison. Block 349 determines if the second opinion relating to comparison of secondary biometric information should occur at APW biometric terminal 300 or at a network server. This decision may depend upon where the corresponding secondary biometric samples were stored when the employee was register onto the system. If further processing is to occur at APW biometric terminal 300, block 350 determines whether human intervention is needed. If a determination is made to use the APW biometric terminal, APW biometric terminal 350 processes one or more of the secondary biometric information files to determine if there is a match at block 352. If so, the person is authenticated.

If human intervention was required at block 350, the secondary biometric information is reviewed at block 353 by a manager. If a match is determined at block 354, the person is authenticated. Otherwise, if there is not match at block 354, the person is not authenticated at block 366.

If the comparison of secondary biometric information at block 349 determines that further processing should occur at the network server, the process moves to block 360, where the secondary biometric information is sent to the server for review. At the server, the review steps in blocks 361-365 may correspond to the already described review process for blocks 350-354.

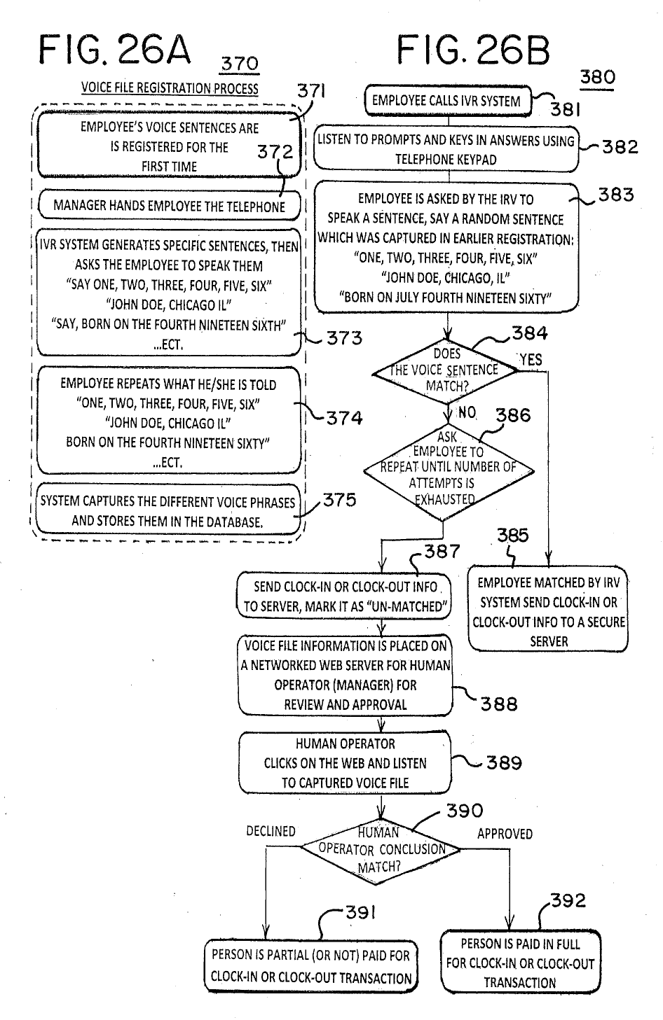

A flowchart 370 in FIG. 26A illustrates typical steps to register a person or employee on an integrated voice response (IVR) system. As explained at starting bubble 371, this involves registering voice sentences or phrases on APW biometric terminal 300 or server 101 which may be used as samples during comparisons at later times. The employee is given a telephone at block 372. The employee is then asked to speak sample sentences at block 373 which the microphone 312 for recording in APW biometric terminal 300 or server 101. At block 374, the employee may again be asked to provide additional voice files. At block 375, the system captures and stores these voice files for later use.

FIG. 26B is a flowchart illustrating typical steps which may be employed to remotely authenticate employees in an interactive voice response (IVR) system, with a second opinion provided by human intervention when the IVR system is unable to confirm a match. At starting bubble 381, the employee calls into the IVR system. At block 382, the employee may be asked to provide information from the keypad of the telephone, such as an employee number or a second telephone number. If there is a match with the information entered in block 382, the employee will be asked to speak one or more phrases or sentences which correspond to those used in the registration process of flowchart 370. If there is a voice match at block 385, the employee is authenticated and the person is paid in full at block 392 and the clock in or clock out time is accepted.

If there was not a voice match at block 387, the clock in or clock out time is marked or treated as unmatched at block 387. This requires the intervention of a human or manager to review the voice files at block 388. If the manager determines a match at block 390, the employee is authenticated and the person is paid in full at block 392 and the clock in or clock out time is accepted. However, if there is no match, the person may be paid partially or not at all at block 391. However, the clock in or clock out time may be recorded in the system for later use. Additionally, the employee may be permitted to work since there may be no temporary or backup person immediately available.

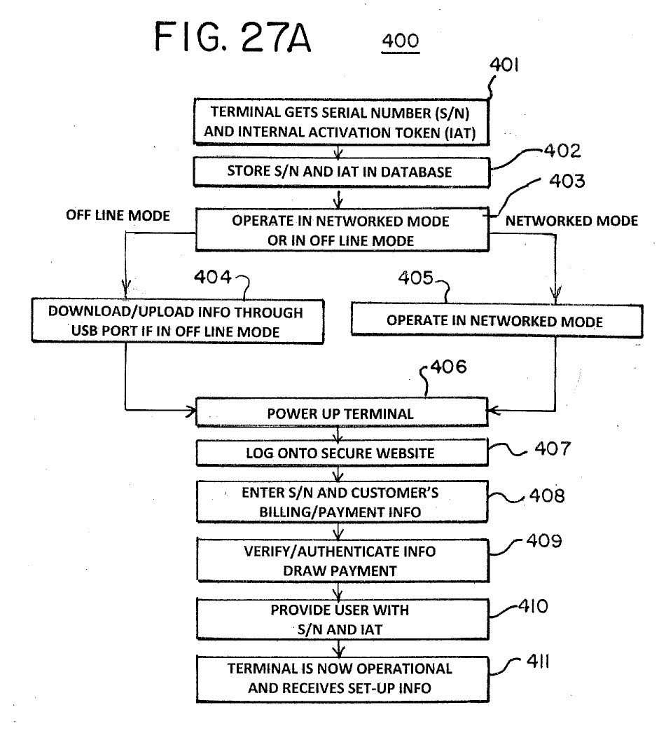

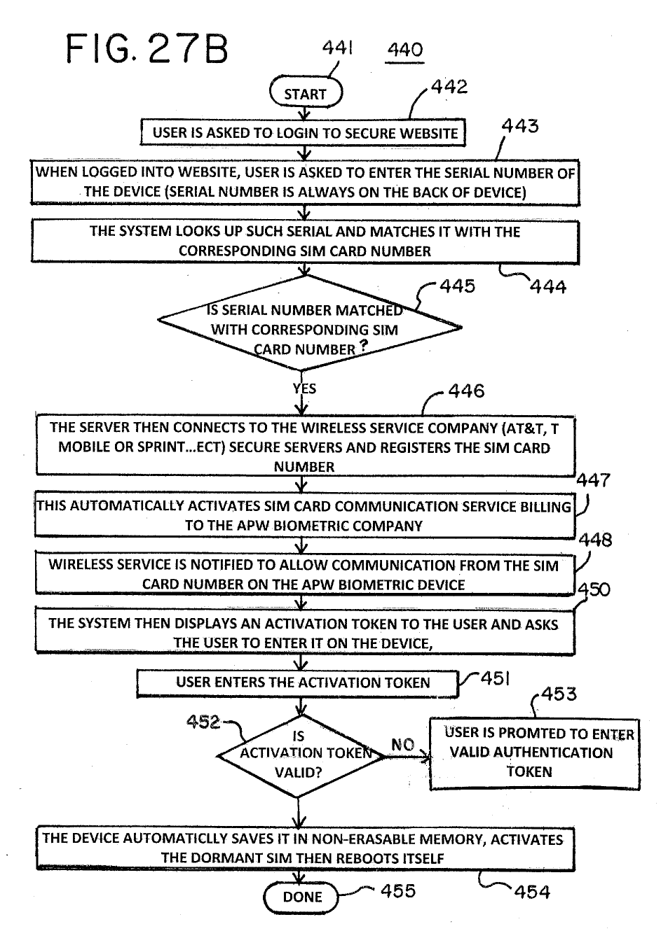

FIG. 27A illustrates a flowchart 400 which contains typical steps which may be utilized to quickly activate an APW biometric terminal, such as APW biometric terminal 300 in FIG. 23, upon its installation in its place of use. In the first block 401, the APW biometric terminal is given a serial number and an internal activation token prior to sale of the APW biometric terminal or installation in its intended place of use. The assigned serial number and activation token are stored in a secure database in block 402. Block 403 requests whether the customer wants to operate the unit in a networked mode or in an off-line non-networked mode. If operating in the off-line mode at block 404, information will be downloaded and uploaded directly from the APW biometric terminal's USB port. If operating in the networked mode at block 405, the user needs to enter a token code in order to communicate with the network.

Once APW biometric terminal 300 has received its initialization information via the upload at block 404 or via a network connection at block 405, the APW biometric terminal is powered up at block 406. Entry of a correct temporary activation key at block 406, permits the APW biometric terminal to log onto a secure website and permits the user to enter the APW biometric terminal's serial number at block 408. The customer is then requested to enter the appropriate billing and payment information. When the entered information is verified and authenticated at block 409, an initial payment is drawn, and the user is provided with the activation token which was previously paired and stored with the APW biometric terminal's serial number, at block 410. When the customer enters the activation token on the APW biometric terminal at block 411, the APW biometric terminal 300 receives set-up information and becomes operational. Thus, the customer or one of its employees can easily self-install and self-activate the APW biometric terminal 300, without the need for any technician to travel to the customer's work site to install the APW biometric terminal.

FIG. 27B illustrates a flowchart 440 which contains typical steps which the APW biometric terminal 300 utilizes during the self-activation process shown in FIG. 27A to wirelessly communicate with a wireless telephone company. After the start bubble 441, when APW biometric terminal 300 is logged onto the secure website, as in block 407 of FIG. 27R and block 442 of FIG. 27B, the user is asked to enter the serial number of the APW biometric terminal 300, as in block 408 of FIG. 27A and block 443 of FIG. 27B. At block 444, the system or database looks up the serial number and matches it with a corresponding SIM card number of a SIM card internally disposed in APW biometric terminal 300 at block 444. If the SIM card number matches the entered serial number at block 445, a server, such as one of servers 104-108 in FIG. 8, connects to a wireless telephone company, such as AT&T, T-Mobile, Sprint, or the like, at block 446, and the SIM card number is registered with the wireless telephone company. At block 447, service is automatically activated by the wireless telephone company and billing is sent to the customer's billing information previously entered at block 408 in FIG. 27A. The wireless telephone company then permits wireless communications associated with the SIM card to/from APW biometric terminal 300 at block 448. Once communication is established between APW biometric terminal 300 and the wireless telephone company, an activation token is displayed to the user/customer at blocks 410 in FIGS. 27A and 450 in FIG. 27B. The user enters the activation token at block 451, the system or database determine if the token is valid at block 452, and the token is stored in non-erasable memory of the APW biometric terminal 300 at block 454. The APW biometric terminal 300 then activates the dormant SIM card and reboots itself at block 454. Upon reboot, APW biometric terminal 300 configures the dormant SIM card, which enables APW biometric terminal 300 to communicate, such as by GPRS methodology. Thus, set-up with a wireless telephone company is complete at block 455.

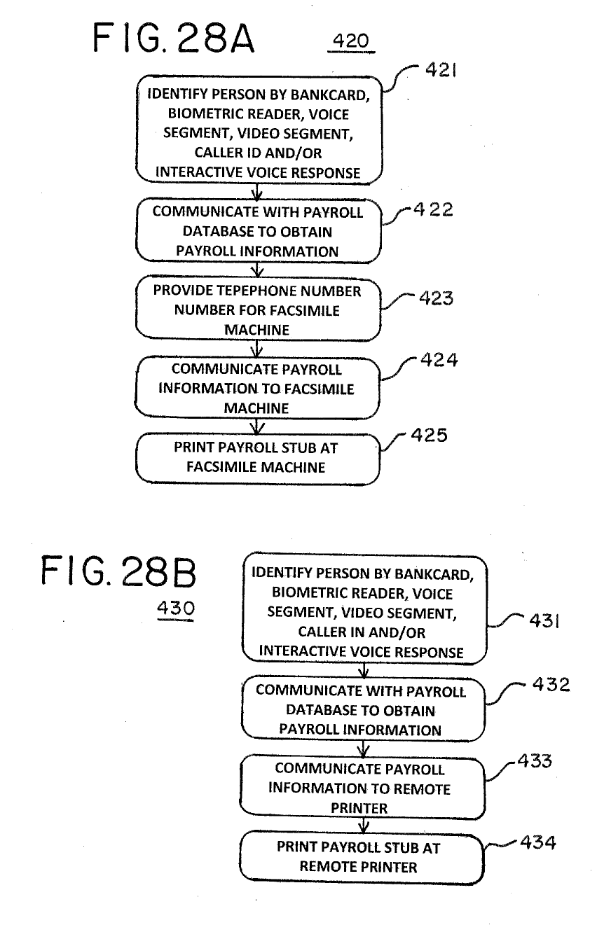

FIG. 28A illustrates a flowchart 420 which contains typical steps which may be used to print a payroll stub at a facsimile machine. At block 421, a person or employee is identified. The means of identification may be by a bankcard, by a fingerprint reader, by a voice segment, by a video segment, by caller identification (ID) and/or by interactive voice response. For example, the card reader 22 of APW biometric terminal 300 may be used for a bankcard, the high resolution microphone 312 may be used for a voice segment, the high-resolution video camera 310 may be used for a video segment, and the interactive voice response system of FIGS. 26A and 26B may be used for an interactive voice response and for caller ID. At block 422, the APW biometric terminal or voice response system communicates with a payroll database to obtain the payroll information for the identified person. At block 423, the person provides a telephone number for the facsimile machine which he/she wants the payroll stub printed. The payroll information is then communicated to the telephone number of the facsimile machine at block 424. At block 425, the payroll stub is printed at the facsimile machine.

FIG. 28B illustrates a flowchart 430 which contains typical steps which may be used to print a payroll stub at a remote printer. At block 431, a person or employee is identified. The means of identification may be as above with respect to block 421 in FIG. 28A. At block 432, the APW biometric terminal or voice response system communicates with a payroll database to obtain the payroll information for the identified person. At block 433, the payroll information is then communicated to a remote printer. At block 434, the payroll stub is printed at the remote printer.

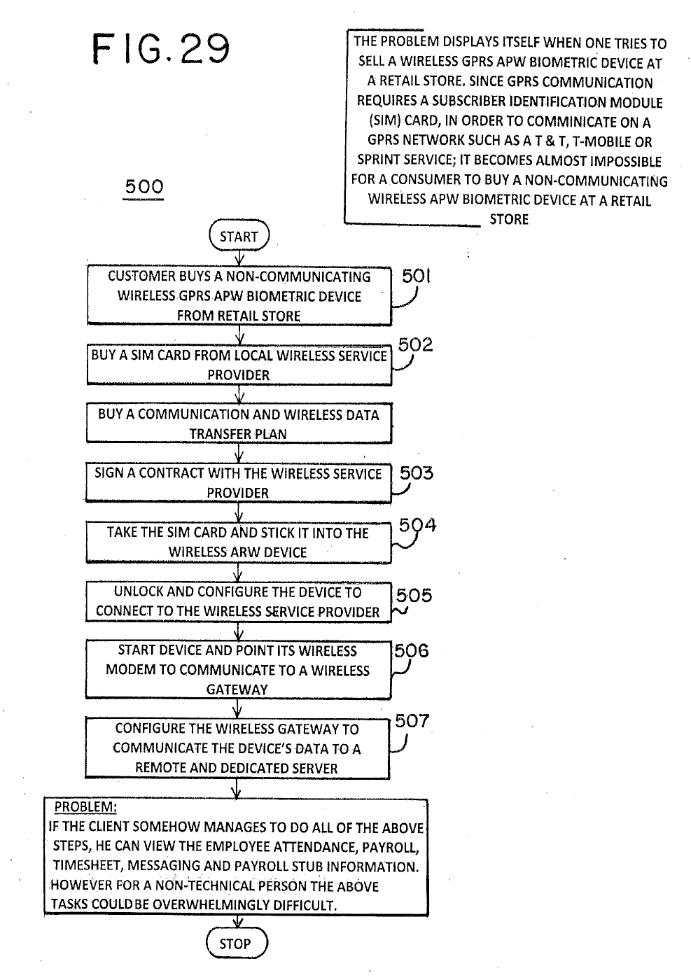

FIG. 29 is a flowchart 500 illustrating the difficulties that a typical customer has with respect to purchasing a non-communicating wireless GPRS APW biometric terminal and configuring the terminal into a communicating mode. The problem displays itself when one tries to sell a wireless GPRS APW biometric device at a retail store. Since GPRS communication requires a Subscriber Identification Module (SIM) card, in order to communicate on a GPRS network such as AT&T, T-Mobile or Sprint service; it becomes almost impossible for a consumer to buy a non-communicating wireless APW biometric device at a retail store (block 501), walk to the local wireless service provider store, buy a SIM card (Subscriber Identification Module card) (block 502), sign a contract with the wireless service provider (AT&T, T-Mobile or Sprint service) (block 503), commit to a specific level of wireless data and voice communication plan, take the SIM card and stick it into the wireless APW device (block 504), unlock and configure the device to connect to the service provider (block 505), then start the device and point its wireless modem to communicate to a wireless gateway (block 506), then configure the wireless gateway to communicate the device's data to a remote and dedicated server (block 507) onto which the client can view employee attendance, payroll, timesheet, messaging and payroll stub information. All such steps are very difficult for a typical consumer to do in a coordinated and error free way.

FIG. 30 is a flowchart 510 illustrating the difficulties that a typical customer has with respect to having third parties assist in installing an off-the-shelf GPRS APW biometric terminal. Currently when a client purchases a biometric device (block 511), the manufacturer (or selling organization) either sends a trained technician to help install and setup the device for the client (block 512), or expect the client to train themselves and install and setup the device on their own. Such activation and implementation logic works fine when the client is known after the sale. However, when the client is unknown (block 513), and he or she buys an off the shelf unit, there is no way for them to self-activate the device without the intervention and presence (local or via a remote conversation) of trained support person. Furthermore, if the client were to rent the device (block 514), and if the client is current on his or her wireless communication fees (note 515), but non-current on his or her monthly hardware rental fees, then because the wireless service is offered via a different provider than the hardware owner, it becomes difficult to stop the device from communicating on the wireless network, primarily because the wireless service company has no intention to stop the user from using its network. An idea comes to mind, which to bundle the wireless service with the rental of the device (block 515), however, such action means that the SIM card installed into the device (to enable GPRS wireless service) has to be activated at manufacturing (block 516), this way, the buyer of the device does not have to go through the hassle of pulling the SIM card, walking to the wireless service store, signing a wireless contract and activating it after the sale of the unit. Activating the SIM card at manufacturer results in the wireless service provider invoicing the APW manufacturer for wireless services from the first day of inception of the APW biometric device. This is a very unattractive business model for the APW manufacturer because the device could be sitting for a year or two in the retail store before sale (block 517). Thus, providing an intelligent remote activation and communication method saves the manufacturer and the user a lot of time and money and simplifies the process of selling a wireless APW biometric device (block 518).

The present invention therefore includes methods of automating the remote sale, activating and implementing a wireless, LAN or dialup APW biometric device operation when sold at a retail location, even though the client is unknown. This method manifests itself greatly when selling a wireless GPRS device with a pre-installed SIM card.

FIG. 31 is a flowchart 520 illustrating methods of enabling a customer to activate a GPRS APW biometric terminal. These intelligent remote activation and communication methods are made effective by enabling the device to always communicate to a home server (in LAN, dialup, or wireless connectivity mode) (block 521) independently of system knowledge of the customer (block 522) and his or her payment status (block 523). To solve the problem, the APW biometric device is pre-manufactured to support multiple communication capabilities (block 524): LAN (block 525), dialup (block 526), and wireless (block 527) simultaneously. The device is pre-installed with a dormant inactive SIM card which can only be activated electronically (block 528). The pre-installed dormant inactive SIM card increases the cost of the device. However, it simplifies its activation and communication once sold to a consumer.

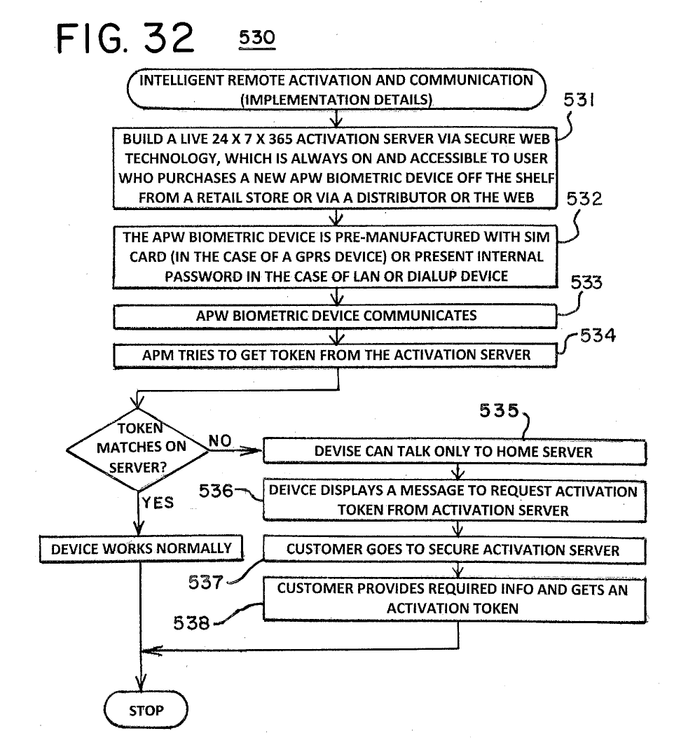

FIG. 32 is a flowchart 530 illustrating the activation details for a GPRS APW biometric terminal. Our approach includes building a live 24×7×365 activation server via secure web technology, which is always on and which is accessible to users who purchase a new APW biometric device off-the-shelf from a retail store, via a distributor, or via the web (block 531). The APW biometric device is pre-manufactured with a SIM card (in the case of a GPRS device) or present internal password in the case of a LAN or dialup device (block 532). Every time the APW biometric device communicates (block 533), it has to get a token from the activation server (block 534). If the device does not have an activation server, it is allowed to only talk to the home server (block 535), while a message is displayed to the user asking them to enter an activation token (block 536), and by giving them the option to go to a secure website (block 537) and attain an activation token (block 538).

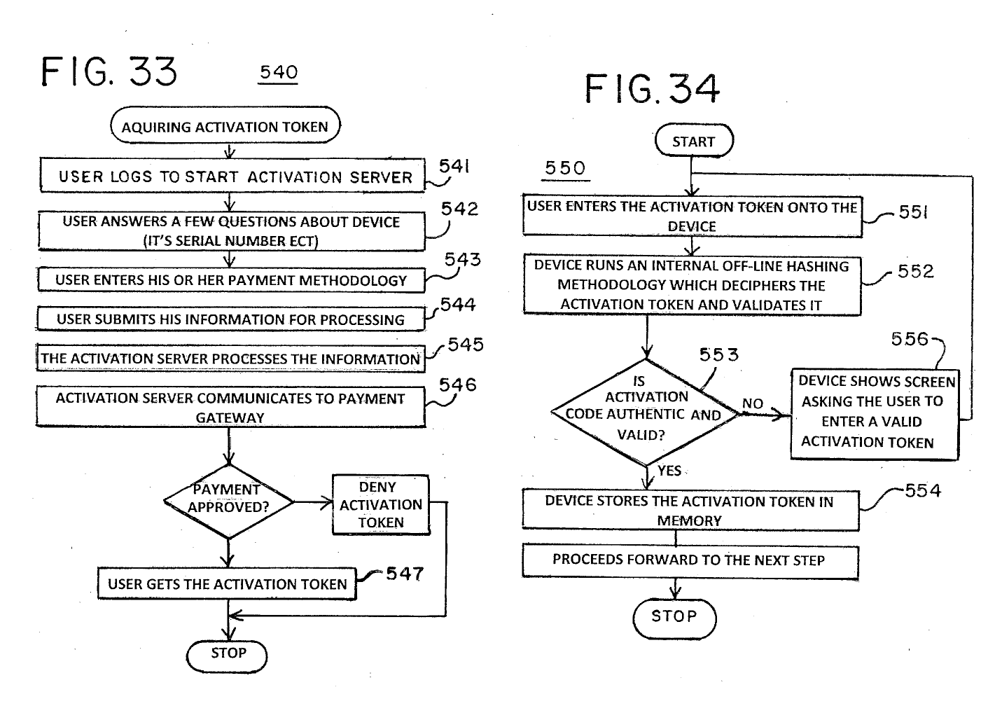

FIG. 33 is a flowchart 540 illustrating a method for acquiring an activation token for a GPRS APW biometric terminal. The user logs onto the activation server system (block 541), answers a few questions (block 542), enters his or her payment methodology (block 543), and then submits his information for processing (block 544). The activation server processes the information (block 545), receives approved payment (block 546), and then presents the user with an activation token (block 547).

FIG. 34 is a flowchart 550 illustrating how the GPRS APW biometric terminal and the system use the activation token. The user enters the activation token onto the device (block 551), the device runs an internal off-line hashing methodology which deciphers the activation token and validates it (block 552). If the code is authentic and if it is valid (block 553), the device stores the activation token in memory (block 554) and proceeds forward to the next step (block 555). Otherwise, it reverts back to asking the user to enter a valid activation token (block 556).

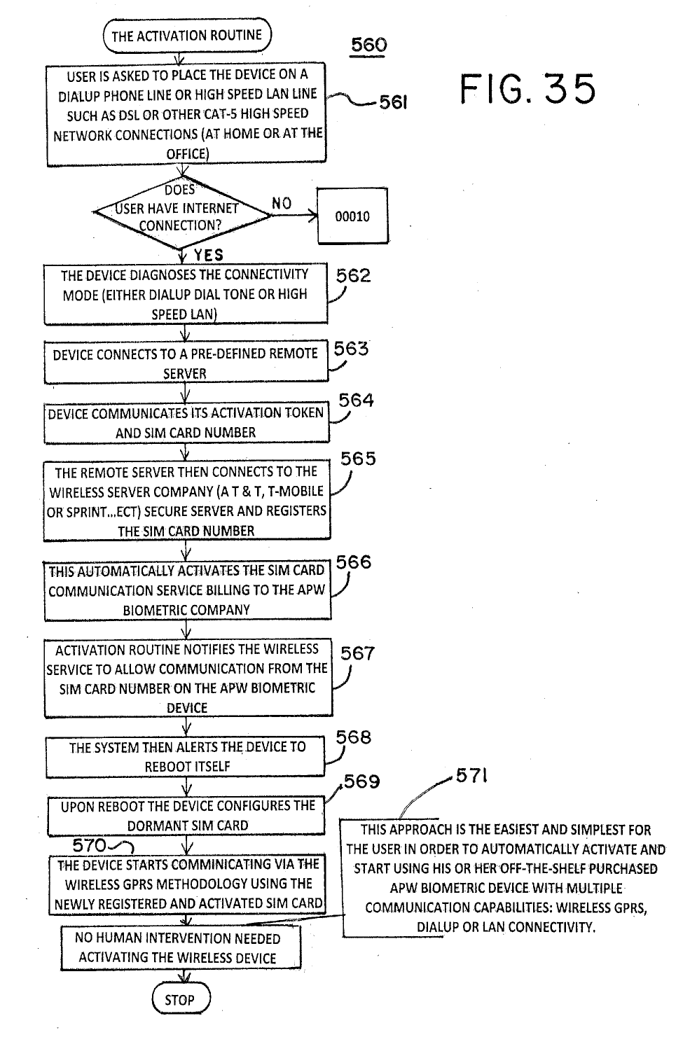

FIG. 35 is a flowchart 560 illustrating a method of remotely activating a GPRS APW biometric terminal by a typical customer. To activate the unit, the user is now asked to place the device on a dialup phone line or high speed LAN line such as DSL or other Cat-5 high speed network connections (at home or at the office) (block 561). The device diagnoses the connectivity mode (either dialup dial-tone or high speed LAN) (block 562), connects to a pre-defined remote server (block 563) and communicates its activation token and SIM card number (block 564). The remote server then connects to the wireless service company (AT&T, T-Mobile, Sprint, or the like) secure servers and registers the SIM card number (block 565). This automatically activates SIM card communication service billing to the company (block 566) and notifies the wireless service to allow communication from the SIM card number on the APW biometric device (block 567). The system then alerts the device to reboot itself (block 568), activates the dormant SIM card (block 569) and start communicating via the wireless GPRS methodology using the newly registered and activated SIM card (block 570). This approach is the easiest and simplest for the user in order to automatically activate and start using his or her off-the-shelf purchased APW biometric device with multiple communication capabilities: wireless GPRS, dialup or LAN connectivity (note 571).

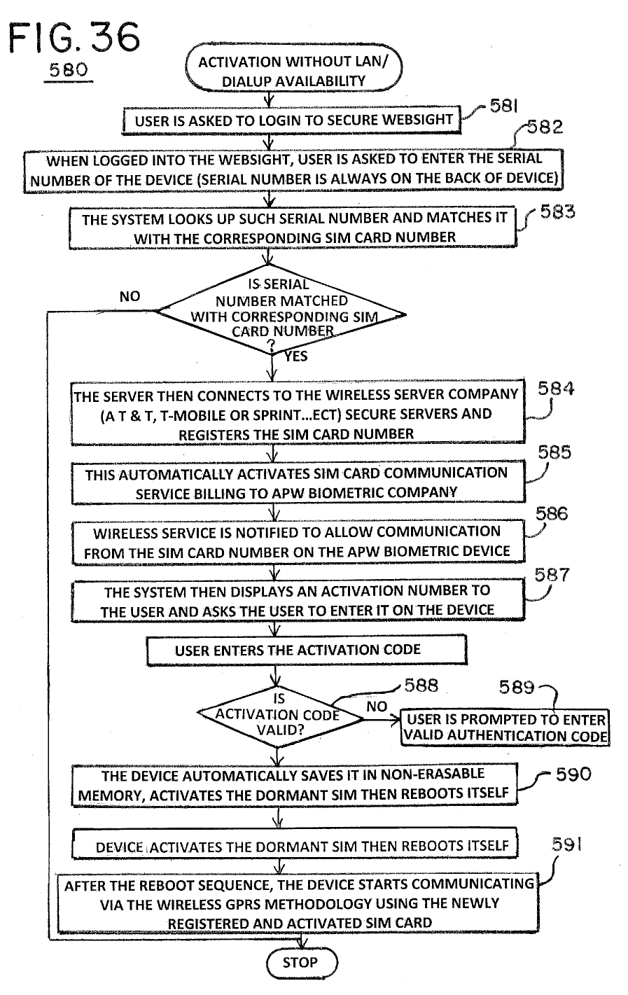

FIG. 36 is a flowchart 580 illustrating method of remotely activating a GPRS APW biometric terminal by a typical customer when an LAN and dialup services are not available. Another method, in case the user does not have access to a dialup connection or LAN, which is slightly more complicated for a user, is to ask the user to log into a secure web site (block 581) where he or she is asked to enter the serial number of the device (serial number is always on the back of device) (block 582). Upon entering the serial number, the system looks up such serial number and matches it with the corresponding SIM card number (block 583). The server then connects to the wireless service company (AT&T, T-Mobile, Sprint, or the like) secure servers and registers the SIM card number (block 584). This automatically activates SIM card communication service billing to the company (block 585) and notifies the wireless service to allow communication from the SIM card number on the APW biometric device (block 586). The system then displays an activation code to the user, and asks the user to enter it on the device (block 587), which validates it and, if successful moves to the next step. If the code is not valid (block 588), then the user is prompted to enter a valid activation token (block 589). Once the user enters a valid activation token, the device automatically saves it in non-erasable memory, activates the dormant SIM, and then reboots itself (block 590). After the reboot sequencer the device starts communicating via the wireless GPRS methodology using the newly registered and activated SIM card (block 591). This approach is slightly more complicated for an unsophisticated user. However, it is an efficient approach to automatically activate and start using an off-the-shelf purchased APW biometric device via multiple communication capabilities: wireless GPRS, dialup or LAN connectivity.

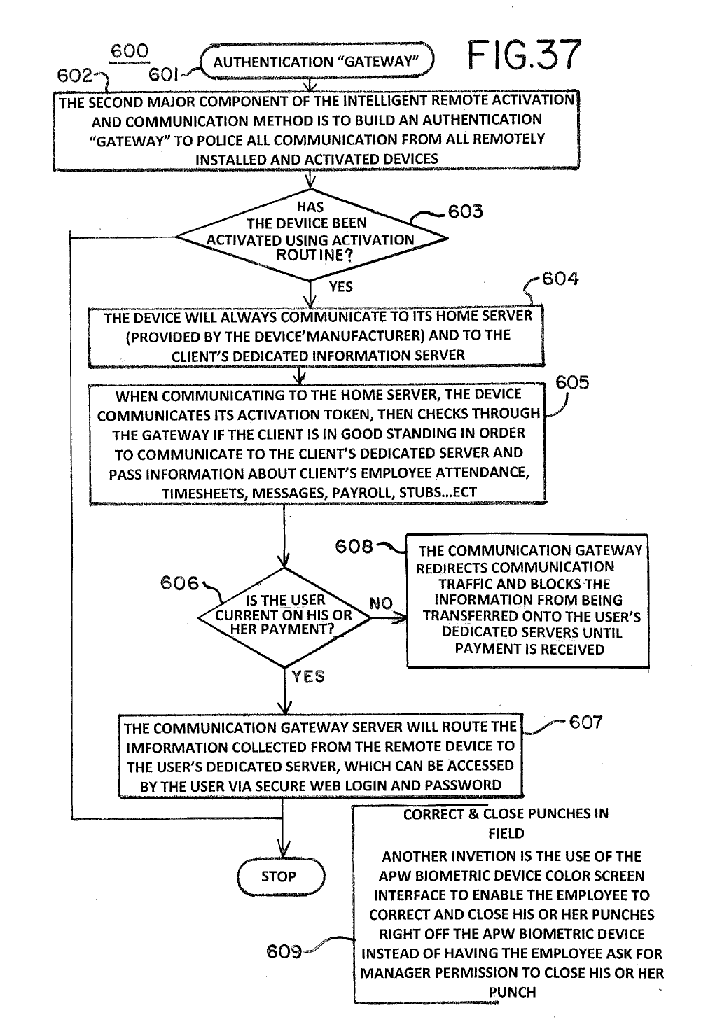

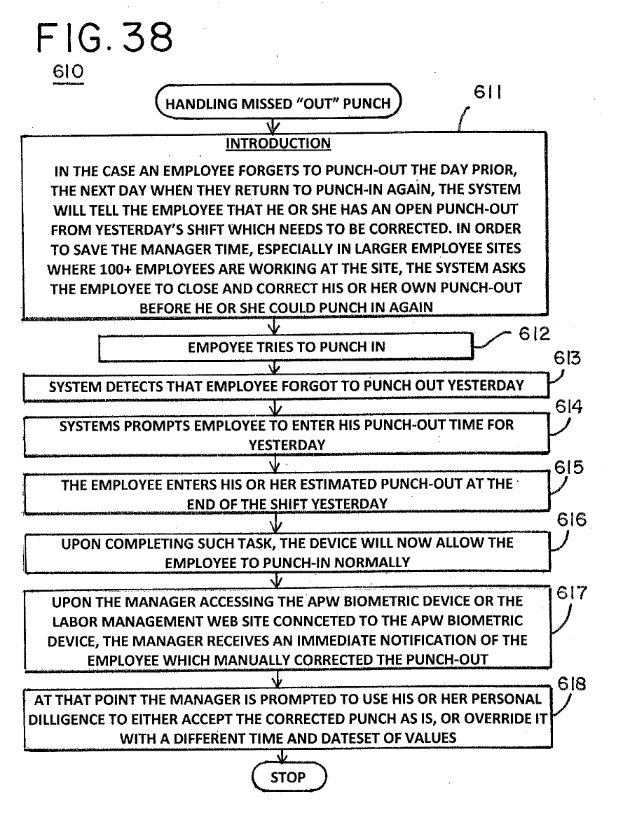

FIG. 37 is a flowchart 600 of an authentication gateway. The second major component of the intelligent remote activation and communication method is to build an authentication “Gateway” (block 601) to police all communication from all remotely installed and activated devices (block 602). Once the device is activated (block 603), the device will always communicate to its home server (provided by the device's manufacturer) and to the client's dedicated information server (block 604). When communicating to the home server, the device communicates its activation token, then checks through the gateway if the client is in good standing in order to communicate to the client's dedicated server and pass information about client's employee attendance, timesheets, messages, payroll stubs, and the like (block 605). Using this process, If the user is current on his or her payment (block 606), then the communication Gateway server will route the information collected from the remote device to the user's dedicated server, which can be accessed by the user via a secure web login and password (block 607). If the user is not current on his or her payments, then the communication Gateway redirects communication traffic and blocks the information from being transferred onto the user's dedicated servers until payment is received (block 608). Another aspect of the present invention is to use the APW Biometric device color screen interface to enable the employee to correct and close his or her punches right off of the APW biometric device, instead of having the employee ask for manager permission to close his or her punch (note 609).

FIG. 38 is a flowchart 610 illustrating a method for handling a missed punch-out by an employee. In the case an employee forgets to punch-out the day prior (block 611), the next day when they return to punch-in again (block 612), the system will tell the employee that he or she has an open punch-out from yesterday's shift (block 613) which needs to be corrected (block 614). In order to save the manager time, especially in larger employee sites where 100 or more employees are working at the site, the system asks the employee to close and correct his or her own punch-out before he or she can punch-in again. The employee enters his or her estimated punch-out time at the end of the shift yesterday (block 615), upon completing such task, the device will now allow the employee to punch-in normally (block 616). Upon the manager accessing the APW biometric device or the labor management web site connected to the APW biometric device, the manager receives an immediate notification of the employee which manually corrected the punch-out (block 617). At that point, the manager is prompted to use his or her personal diligence to either accept the corrected punch as is, or override it with a different time and date set of values (block 618).

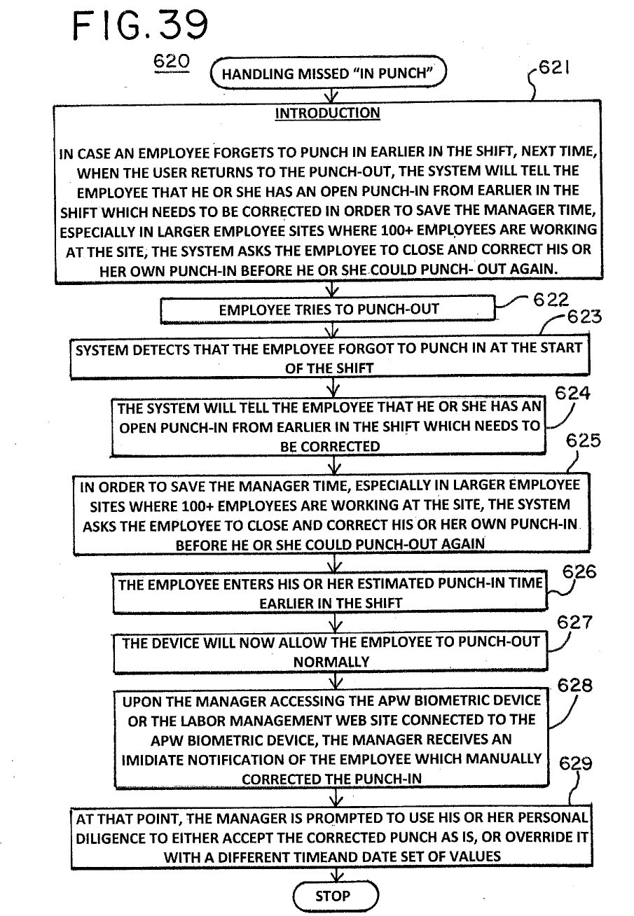

FIG. 39 is a flowchart 620 illustrating a method for handling a missed punch-in by an employee. In the case an employee forgets to punch-in earlier in the shift (block 621), next time, when the user returns to punch-out (block 622), the system will tell the employee that he or she has an open punch-in from earlier in the shift (block 623) which needs to be corrected (block 624). In order to save the manager time, especially in larger employee sites where 100 or more employees are working at the site, the system asks the employee to close and correct his or her own punch-in before he or she could punch-out again (block 625). The employee enters his or her estimated punch-in time earlier in the shift (block 626), upon completing such task, the device will now allow the employee to punch-out normally (block 627). Upon the manager accessing the APW biometric device or the labor management web site connected to the APW biometric device, the manager receives an immediate notification of the employee which manually corrected the punch-in (block 628). At that point, the manager is prompted to use his or her personal diligence to either accept the corrected punch as is, or override it with a different time and date set of values (block 629).

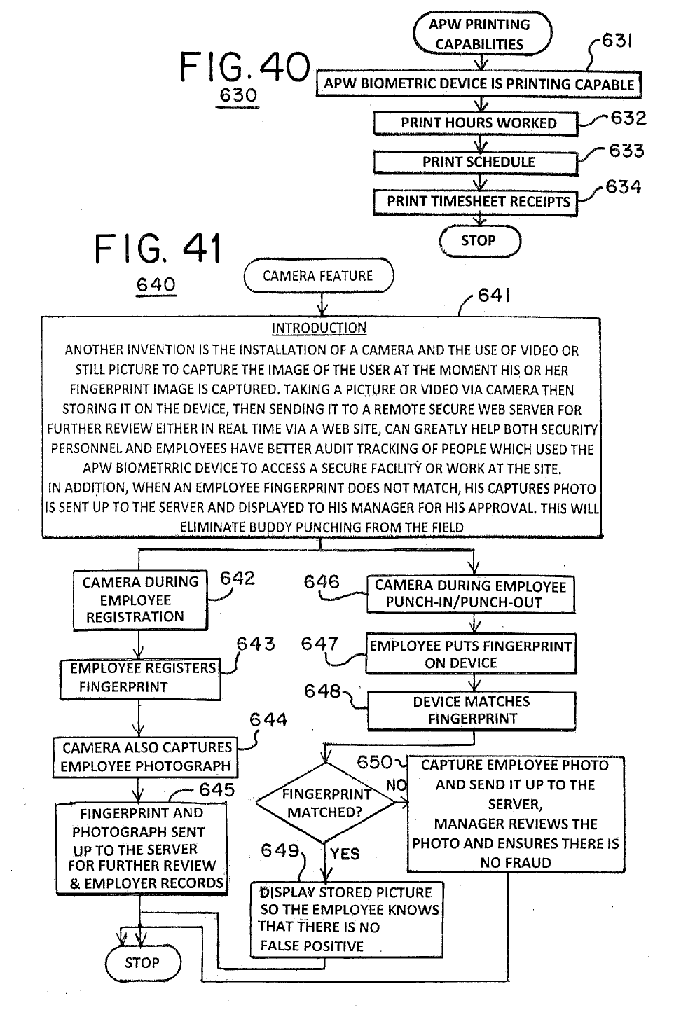

FIG. 40 is a flowchart 630 illustrating the printing capabilities of a GPRS APW biometric terminal. Another aspect of the present invention is the use of the APW biometric device (block 631) to print hours worked (block 632), schedule (block 633), assignments and timesheet receipts (block 634).

FIG. 41 is a flowchart 640 illustrating methods of using a camera on a GPRS APW biometric terminal. Still another aspect of the present invention is the installation of a camera and the use of video or still picture to capture the image of the user at the moment his or her fingerprint image is captured. Taking a picture or video via a camera then storing it on the device, then sending it to a remote secure web server for further review either in real time via a web site, can greatly help both security personnel and employers have better audit tracking of people who used the APW biometric device to access a secure facility or work at the site (block 641). For example, the camera can be used during employee registration (block 642) by the employee registering his/her fingerprint on the fingerprint reader (block 643) with the camera also capturing an employee photograph (block 644) and the fingerprint and photograph data sent to a server for review and/or for future comparisons (block 645). The camera may also be used during punch-out of an employee (block 646) such as when the employee puts his fingerprint on the device (block 647), and the fingerprint is matched (block 648). The picture may then be stored so that the employee knows that there is no false positive in the fingerprint matching (block 649), or the picture may be stored so that a manager can review the picture if there is no fingerprint match (block 650).

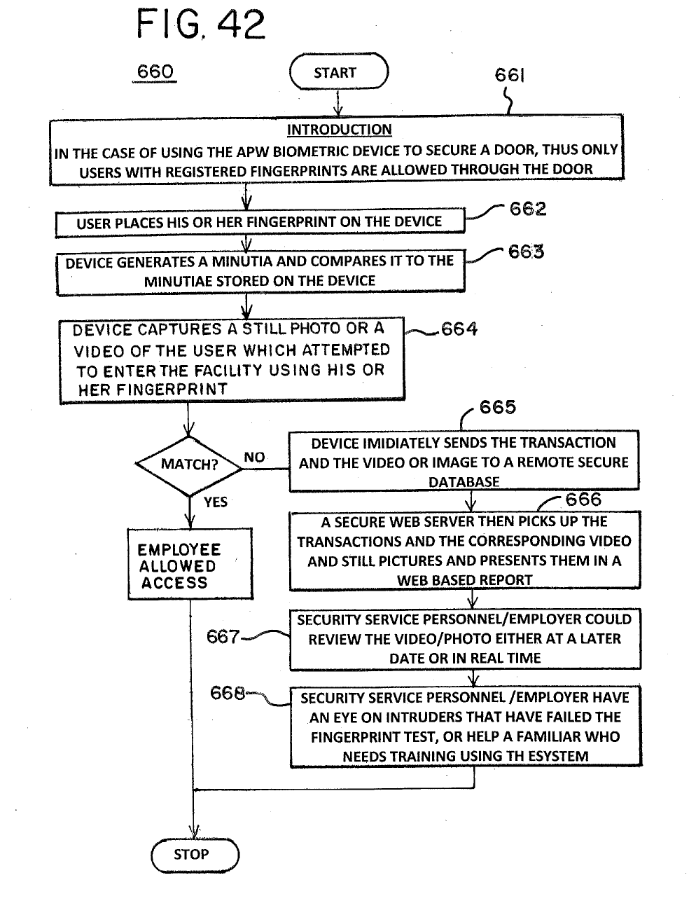

FIG. 42 is a flowchart 660 illustrating methods of using a GPRS APW biometric terminal to control access to a secure door, to a secure building or the like. APW biometric device may also be used to secure a door, thus only users with registered fingerprints are allowed through the door (block 661). A user places his or her fingerprint on the device (block 662), which reads their fingerprint, generates a minutia and compares it to the set of minutiae stored on the device (block 663). In case of a match or no match, the device captures a quick video, or a still picture of the user which attempted to enter the facility using his or her fingerprint (block 664). Then the device immediately sends the transaction and the video or image to a remote secure database (block 665). A secure web server then picks up the transactions and the corresponding video and still pictures and presents them in a web based report (block 666); so that security service personnel can review either at a later date or in real time (block 667); thus have an eye on intruders who have failed the fingerprint test, or help identify a familiar face who may need training in the use of the system (block 668).

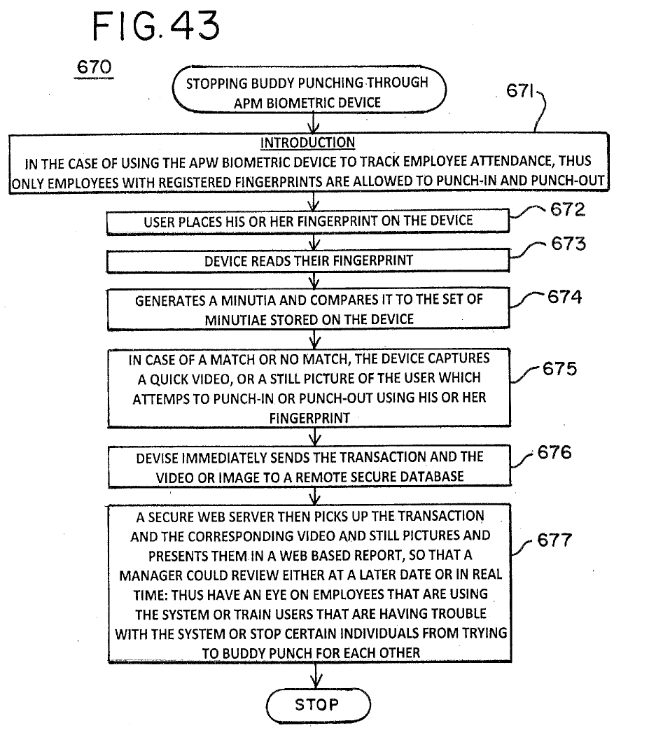

FIG. 43 is a flowchart 670 illustrating methods for controlling buddy punching at a GPRS APW biometric terminal. In the case of using the APW biometric device to track employee attendance, thus only employees with registered fingerprints are allowed to punch-in and punch-out (block 671). A user places his or her fingerprint on the device (block 672), which reads their fingerprint (block 673), generates a minutia and compares it to the set of minutiae stored on the device (block 674). In case of a match or no match, the device captures a quick video, or a still picture of the user which attempted to punch-in or punch-out using his or her fingerprint (block 675). Then immediately sends the transaction and the video or image to a remote secure database (block 676). A secure web server then picks up the transactions and the corresponding video and still pictures and presents them in a web based report; so that a manager can review either at a later date or in real time: thus have an eye on employees that are using the system or help train users that are having trouble with the system or stop certain individuals from trying to buddy punch for each other (block 677).

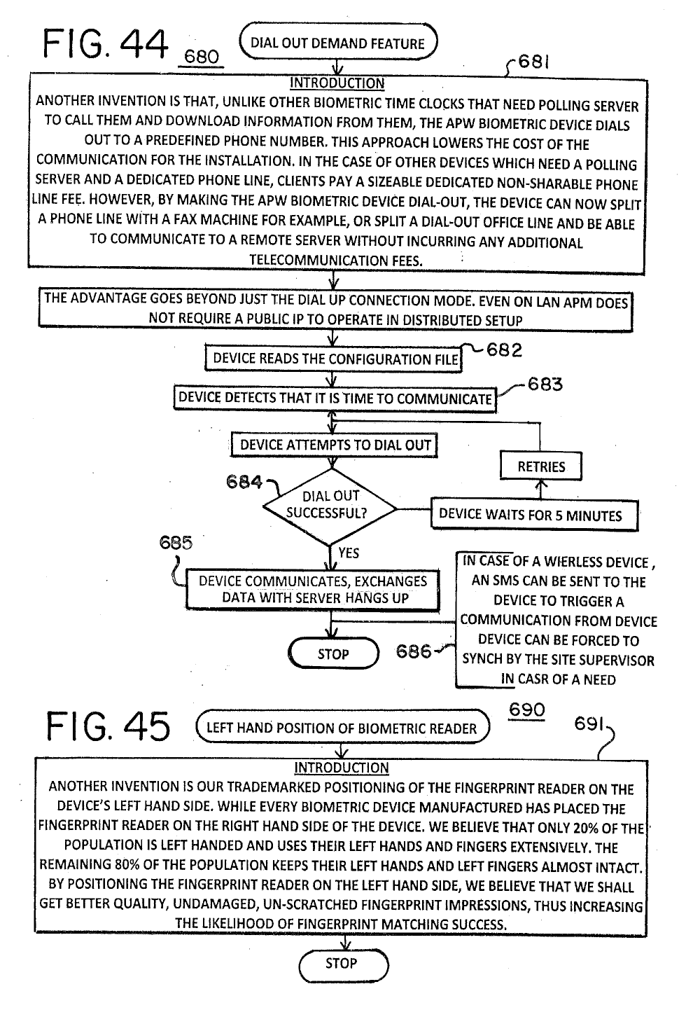

FIG. 44 is a flowchart 680 illustrating a method for dialing out on demand from a GPRS APW biometric terminal. Another aspect of the present invention is that, unlike other biometric time clocks that need a polling server to call them and download information from them, the APW biometric device dials out to a predefined phone number. This approach lowers the cost of communication for the installation. In the case of other devices which need a polling server and a dedicated phone line, clients pay a sizeable dedicated non-sharable phone line fee. However, by making the APW biometric device dial-out, the device can now split a phone line with a fax machine, for example, or split a dial-out office line and be able to communicate to a remote server without incurring any additional telecommunication fees (block 681). For example, the biometric terminal may read the configuration file (block 682), detect that it is time to communicate (block 683), and attempts to dial out (block 684). If the dial out is successful (block 684), the terminal communicates, exchanges data with a server, and hangs up (block 685). In the case of a wireless terminal, an SMS can be sent from the terminal to trigger a communication, or the terminal can be forced into sync with the system by a site supervisor (note 686).

FIG. 45 is a flowchart 690 illustrating the left-hand position of the biometric reader. Yet another aspect of the present invention is to position the fingerprint reader on the device's left hand side. Other biometric device manufacturers place the fingerprint reader on the right hand side of the device. We believe that only about 20 percent of the population is left-handed and, as such, use their left hands and fingers extensively. The remaining about 80 percent of the population keeps their left hands and left fingers relatively unused. By positioning the fingerprint reader on the left-hand side of the device, better quality, undamaged, un-scratched fingerprint impressions are obtained, thus increasing the likelihood of fingerprint matching success (block 691).

While particular embodiments of the invention have been shown and described, it will be apparent to those skilled in the art that changes and modifications may be made therein without departing from the invention in its broader aspects, and, therefore, the aim of the appended claims is to cover all such changes and modifications as fall within the true spirit and scope of the invention.

1. A time and attendance terminal for communicating with a payroll system, said time and attendance terminal communicating with said payroll system via general packet radio service (GPRS) protocol.

2. The time and attendance terminal in accordance with claim 1 wherein said payroll system also includes a work management system.

3. The time and attendance terminal in accordance with claim 1 wherein the time and attendance terminal includes circuitry for encoding and decoding communications between the time and attendance terminal and the payroll system in accordance with general packet radio service (GPRS) protocol.

4. A method for activating a time and attendance terminal which communicates with a payroll system, said method comprising the steps of:
providing the time and attendance terminal with a serial number and an internal activation token,
storing the serial number and the internal activation token in a database,
powering up the time and attendance terminal,
logging the time and attendance terminal onto a secure website,
entering payment information into the time and attendance terminal,
verifying the payment information, and
providing the serial number and activation token from the database to a user at the time and attendance terminal.

5. The method for activating a time and attendance terminal in accordance with claim 4, further comprising the step of:
determining whether to operate the time and attendance terminal in an off line mode or in a networked mode prior to the step of powering up the time and attendance terminal.

6. The method for activating a time and attendance terminal in accordance with claim 4, further comprising the step of:
entering the serial number and the activation token to render the time and attendance terminal operational.

7. The method for activating a time and attendance terminal in accordance with claim 6, further comprising the step of:
receiving set-up information from the secure website to set-up the time and attendance terminal.

8. A method of printing a payroll stub at a facsimile machine comprising the steps of:
identifying a person,
communicating with a payroll database to obtain payroll information for the identified person,
providing a telephone number associated with the facsimile machine,
communicating the payroll information for the identified person to the facsimile machine, and
printing the obtained payroll information at the facsimile machine as a payroll stub.

9. The method of printing a payroll stub at a facsimile machine in accordance with claim 8 wherein the identified person provides the telephone number associated with the facsimile machine.

10. The method of printing a payroll stub at a facsimile machine in accordance with claim 9 wherein the person is identified by an interactive voice response system.

11. The method of printing a payroll stub at a facsimile machine in accordance with claim 8 wherein the person is identified by at least one of the group consisting of a bankcard, a biometric reader, a voice segment, a video segment or caller ID.

12. A method of printing a payroll stub at a remote printer comprising the steps of:
identifying a person,
communicating with a payroll database to obtain payroll information for the identified person, communicating the payroll information for the identified person to the remote printer, and
printing the obtained payroll information at the remote printer as a payroll stub.

13. The method of printing a payroll stub at a remote printer in accordance with claim 12 wherein the person is identified by at least one of the group consisting of a bankcard, a biometric reader, a voice segment, a video segment or caller ID.

14. The method of printing a payroll stub at a remote printer in accordance with claim 12 wherein the person is identified by an interactive voice response system.
